(19) United States
(12) Patent Application Publication
(10) Pub. No.: US 2019/0068824 A1
(43) Pub. Date: Feb. 28, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Kosuke KUBOTA, Kanagawa (JP); Noriyuki SUZUMURA, Kanagawa (JP); Aya KUWANO, Kanagawa (JP)

(73) Assignee: FUJI XEROX CO., LTD., Tokyo (JP)

(21) Appl. No.: 16/058,341

(22) Filed: Aug. 8, 2018

(30) Foreign Application Priority Data
Aug. 22, 2017 (JP) 2017-159586

(51) Int. Cl. H04N 1/32

(52) U.S. Cl. CPC H04N 1/32368

(57) ABSTRACT

An information processing apparatus includes a receiver and a controller. The receiver receives data from a transmission source. The controller creates a storage location linked with the transmission source and stores the data in the storage location in a case where information related to the transmission source is registered in management information for managing a communication partner.

### CROSS-REFERENCE TO RELATED APPLICATIONS

This application is based on and claims priority under 35 USC 119 from Japanese Patent Application No. 2017-159586 filed Aug. 22, 2017.

### BACKGROUND

### Technical Field

The present invention relates to information processing apparatuses and non-transitory computer readable media.

### SUMMARY

According to an aspect of the invention, there is provided an information processing apparatus including a receiver and a controller. The receiver receives data from a transmission source. The controller creates a storage location linked with the transmission source and stores the data in the storage location in a case where information related to the transmission source is registered in management information for managing a communication partner.

### BRIEF DESCRIPTION OF THE DRAWINGS

Exemplary embodiments of the present invention will be described in detail based on the following figures, wherein:

FIG. 1 is a block diagram illustrating a data management system according to a first exemplary embodiment of the present invention;

FIG. 2 is a block diagram illustrating an image forming apparatus;

FIG. 3 is a block diagram illustrating a server;

FIG. 4 illustrates a setting screen;

FIG. 5 illustrates a setting screen;

FIG. 6 illustrates a setting screen;

FIG. 7 illustrates a setting screen;

FIG. 8 illustrates a setting screen;

FIG. 9 is a diagram for explaining the operational contents of the data management system according to the first exemplary embodiment;

FIG. 10 is a diagram for explaining a data storing process;

FIG. 11 illustrates a setting screen;

FIG. 12 illustrates a setting screen;

FIG. 13 illustrates a setting screen;

FIG. 14 illustrates a setting screen;

FIG. 15 illustrates a setting screen;

FIG. 16 illustrates a setting screen; and

FIG. 17 is a flowchart illustrating the operation of a data management system according to a second exemplary embodiment.

### DETAILED DESCRIPTION

### First Exemplary Embodiment

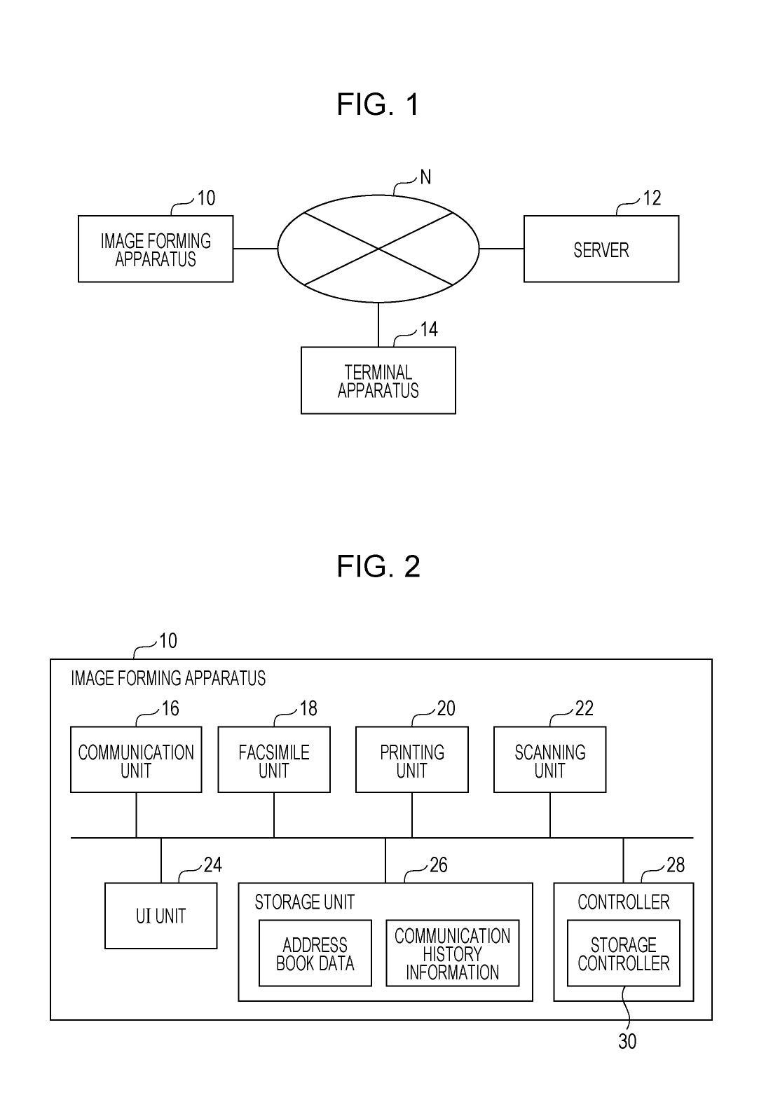

A data management system as an information processing system according to a first exemplary embodiment of the present invention will be described with reference to FIG. 1. In FIG. 1, an example of the data management system according to the first exemplary embodiment is shown.

The data management system according to the first exemplary embodiment includes, for example, an image forming apparatus 10 as an information processing apparatus, a server 12 as an example of an external apparatus, and a terminal apparatus 14. For example, the image forming apparatus 10, the server 12, and the terminal apparatus 14 each have a function of communicating with another apparatus via a communication path N, such as a network.

Alternatively, the image forming apparatus 10, the server 12, and the terminal apparatus 14 may each have a function of communicating with another apparatus via a different communication path without using the communication path N. The data management system may include multiple image forming apparatuses 10, multiple servers 12, and multiple terminal apparatuses 14. The terminal apparatus 14 does not have to be included in the data management system.

The image forming apparatus 10 at least has a facsimile function and a printing function. Specifically, the image forming apparatus 10 has a function of printing facsimile data (e.g., image data) received by facsimile communication onto paper as a recording medium, and also has a function of forwarding the facsimile data to an external apparatus, such as the server 12 or the terminal apparatus 14. Moreover, the image forming apparatus 10 may also have at least one of a scanning function and a copying function.

The server 12 is a data storage apparatus and is, for example, a file-transfer-protocol (FTP) server. In a case where facsimile data is forwarded from the image forming apparatus 10 to the server 12, the server 12 stores the facsimile data therein.

The terminal apparatus 14 is, for example, a personal computer (PC), a tablet PC, a smartphone, or a portable telephone.

In the first exemplary embodiment, in a case where the image forming apparatus 10 receives data from a transmission source and forwards the data to the server 12 such that the server 12 stores the data therein, the data is stored in a storage location (i.e., a folder) linked with information (i.e., identification information) for identifying the transmission source. The data is, for example, facsimile data, an electronic mail, or another type of data (e.g., image data or document data). For example, the identification information is information allocated to the transmission source for performing communication or is the name of the transmission source. The information allocated to the transmission source for performing transmission is, for example, facsimile identification information allocated to the transmission source for performing facsimile communication, an electronic mail address, or an Internet Protocol (IP) address. Alternatively, a media access control (MAC) address of the transmission source may be used as the identification information. Instead of being stored in the server 12, the data may be stored in a folder provided in the image forming apparatus 10 or may be stored in a folder provided in the terminal apparatus 14.

In the first exemplary embodiment, for example, it is assumed that facsimile data is transmitted from the transmission source to the image forming apparatus 10 by facsimile communication, and the facsimile data is stored in the server 12 by being forwarded from the image forming apparatus 10 to the server 12. In this case, the facsimile data is stored in a folder linked with the facsimile identification information of the facsimile data. The facsimile identification information is an example of information included in attribute information of the facsimile data and is allocated to the facsimile-communication transmission source for performing facsimile communication. Specifically, the facsimile identification information is, for example, a facsimile number of the transmission source, a communication number according to the facsimile communication standard (i.e., G3ID in a case where the G3 standard is used), or a dial-in number, and uniquely indicates the transmission source. In a case where the G3 standard is used as the standard, a communication number according to the standard is a G3ID. In a case where a standard other than the G3 standard is used (e.g., the G4 standard), a communication number according to the standard may be used as the facsimile identification number. The information including at least one of a facsimile number, a communication number according to the standard, and a dial-in number mentioned above is linked with a folder, and the facsimile data is stored in the folder. For example, a folder having a folder name that includes the facsimile identification information is created, and the facsimile data is stored in the folder. Instead of being stored in the server 12, the facsimile data may be stored in the image forming apparatus 10 or in the terminal apparatus 14. The following description relates to a case where the facsimile data is stored in the server 12. Moreover, the facsimile identification information will be referred to as “FAX ID”.

The apparatuses included in the data management system according to the first exemplary embodiment will be described in detail below.

The configuration of the image forming apparatus 10 will be described in detail with reference to FIG. 2. FIG. 2 illustrates an example of the configuration of the image forming apparatus 10.

A communication unit 16 is a communication interface and has a function of transmitting data to another apparatus and a function of receiving data from another apparatus. The communication unit 16 may be a communication interface having a wireless communication function or may be a communication interface having a wired communication function. For example, the communication unit 16 forwards facsimile data transmitted to the image forming apparatus 10 by facsimile communication to an external apparatus, such as the server 12, via the communication path N. Furthermore, the communication unit 16 may receive an electronic mail or another type of data (e.g., image data or document data) transmitted to the image forming apparatus 10 from the transmission source via the communication path N and may forward the electronic mail or the data to an external apparatus, such as the server 12, via the communication path N.

A facsimile unit 18 has a function of performing facsimile communication using one or multiple facsimile lines in accordance with the communication standard. For example, the facsimile unit 18 is constituted of a modem for performing facsimile communication. The communication standard is, for example, the G3 standard. Alternately, another communication standard (e.g., the G4 standard) may be used. The following description relates to a case where facsimile communication is performed in accordance with the G3 standard. The facsimile unit 18 exchanges facsimile data by performing facsimile communication with another apparatus (e.g., a facsimile apparatus or an image forming apparatus) having a facsimile function.

A printing unit 20 has a printing function and forms an image or a character string to be printed onto a recording medium, such as paper. A scanning unit 22 has a scanning function and generates scan data (e.g., image data) by reading a document. The printing unit 20 and the scanning unit 22 may realize a copying function. By executing the copying function, a document is read so that an image or a character string is formed on a recording medium.

Furthermore, scan data generated by scanning may be transmitted to an external apparatus. The image forming apparatus 10 does not have to have the printing unit 20 or the scanning unit 22.

A user interface (UI) unit 24 is a user interface and includes a display unit and an operable unit. The display unit is, for example, a display device, such as a liquid crystal display. The operable unit is, for example, an input device, such as a touchscreen or a keyboard. Alternatively, a user interface functioning both as a display unit and an operable unit (e.g., a touch-type display or a device that electronically displays a keyboard on a display) is permissible.

A storage unit 26 is a storage device, such as a hard disk or a memory device. The storage unit 26 stores therein, for example, address book data, communication history information, various types of control data (e.g., job information), address information indicating the addresses of external apparatuses (e.g., address information of the server 12 and the terminal apparatus 14), various types of programs, and various types of data. Furthermore, data transmitted to the image forming apparatus 10 (e.g., facsimile data, an electronic mail, image data, or document data) may be stored in the storage unit 26. Data, such as facsimile data, may be temporarily stored in the storage unit 26 until the data is forwarded to an external apparatus, or may be stored in the storage unit 26 after the data is forwarded to an external apparatus. The various types of information mentioned above may be stored in different storage devices or may be stored in a single storage device.

The address book data is used for managing communication partners and is, specifically, data that includes address information of each communication partner (e.g., facsimile identification information (FAX ID), an electronic mail address, and a telephone number). The address book data corresponds to an example of management information used for managing communication partners and at least includes information indicating, for each communication partner, a correspondence between the name of the communication partner and the FAX ID of the communication partner. The address book data may also include, for example, the telephone number and the electronic mail address of the communication partner, the company and the department to which the communication partner belongs, the residential address of the communication partner, and other personal information. A FAX ID and an electronic mail address allocated to the image forming apparatus 10 may also be registered in the address book data. Moreover, multiple names may be allocated to a single FAX ID. In a case where a user gives a command to display the address book, the various types of information registered in the address book data are displayed on the display unit of the UI unit 24. In a case where a user selects a communication partner from the address book data and gives a command to perform facsimile transmission, the facsimile unit 18 transmits facsimile data to the selected communication partner by facsimile communication. The address book data may be stored in an external apparatus, such as the server 12, instead of being stored in the image forming apparatus 10 or in addition to being stored in the image forming apparatus 10. In this case, when the address book data is displayed, the address book data may be transmitted from the external apparatus to the image forming apparatus 10 so as to be displayed thereon.

The communication history information corresponds to an example of management information for managing each communication partner and indicates the history of communication with the communication partner. For example, the communication history information indicates a correspondence between the time and date of communication and the contents of the communication. For example, in a case where the image forming apparatus 10 transmits facsimile data to another apparatus as a communication partner by facsimile communication, the time and date of the transmission, the communication partner's address information (including the FAX ID), and the name of the communication partner are recorded in the communication history information in correspondence with one another. Likewise, in a case where the image forming apparatus 10 receives facsimile data from another apparatus as a communication partner by facsimile communication, the time and date of the reception, the communication partner's address information, and the name of the communication partner are recorded in the communication history information in correspondence with one another. The histories of transmission and reception of an electronic mail and other types of data (e.g., image data and document data) are also recorded in the communication history information. The communication history information may be stored in an external apparatus, such as the server 12, instead of being stored in the image forming apparatus 10 or in addition to being stored in the image forming apparatus 10.

Furthermore, management information for each user and management information for each image forming apparatus 10 may be created and may be stored in the image forming apparatus 10 or an external apparatus. For example, the management information for each user is linked with information for identifying the user (e.g., a user ID or user identification information, such as a user's name), and the management information for each image forming apparatus 10 is linked with information for identifying the image forming apparatus 10 (e.g., apparatus identification information, such as the ID, the name, the FAX ID, the electronic mail address, the IP address, or the MAC address of the image forming apparatus 10).

For example, address book data may be created for each user and may be stored in the image forming apparatus 10 or an external apparatus. When displaying the address book data, for example, the address book data linked with the user logged in the image forming apparatus 10 (i.e., the address book data for the user) is displayed. Alternatively, address book data may be created for each image forming apparatus 10 and may be stored in the image forming apparatus 10 or an external apparatus. For example, the address book data linked with the image forming apparatus 10 is to be used as shared address book data in the image forming apparatus 10.

Furthermore, communication history information for each user and communication history information for each image forming apparatus 10 may be created and may be stored in the image forming apparatus 10 or an external apparatus. The communication history information for each user indicates the history of communication performed by the user. The communication history information for each image forming apparatus 10 indicates the history of communication performed by the image forming apparatus 10.

A controller 28 has a function of controlling the operation of each component of the image forming apparatus 10. For example, the controller 28 causes the display unit of the UI unit 24 to display various types of information, controls the communication performed by the communication unit 16, and controls the facsimile communication performed by the facsimile unit 18. Moreover, the controller 28 includes a storage controller 30.

The storage controller 30 has a function of controlling storage of data transmitted from the transmission source to the image forming apparatus 10. In the first exemplary embodiment, in a case where the facsimile unit 18 receives facsimile data by facsimile communication, the storage controller 30 stores the facsimile data in a folder (corresponding to an example of a storage location) linked with the FAX ID of the transmission source of the facsimile data. The folder linked with the FAX ID is given the FAX ID as the name of the folder. If a folder linked with the FAX ID of the transmission source is not detected (i.e., if the folder does not exist), the storage controller 30 creates a folder linked with the FAX ID of the transmission source and stores the facsimile data in the folder.

In a case where the facsimile data is to be stored in the server 12, the storage controller 30 stores the facsimile data in a folder linked with the FAX ID of the transmission source of the facsimile data in the server 12. If the server 12 does not have a folder linked with the FAX ID of the transmission source, the storage controller 30 creates a folder linked with the FAX ID of the transmission source within the server 12 and stores the facsimile data in the folder.

The facsimile data may alternatively be stored in the image forming apparatus 10. In this case, the storage controller 30 stores the facsimile data in a folder linked with the FAX ID of the transmission source of the facsimile data in the image forming apparatus 10. If the image forming apparatus 10 does not have such a folder, the storage controller 30 creates a folder linked with the FAX ID of the transmission source within the image forming apparatus 10 and stores the facsimile data in the folder.

As will be described later, in a case where the server 12 has a storage controller 38 and controls storage of facsimile data, the image forming apparatus 10 does not have to have the storage controller 30, or the storage controller 30 does not have to execute its function.

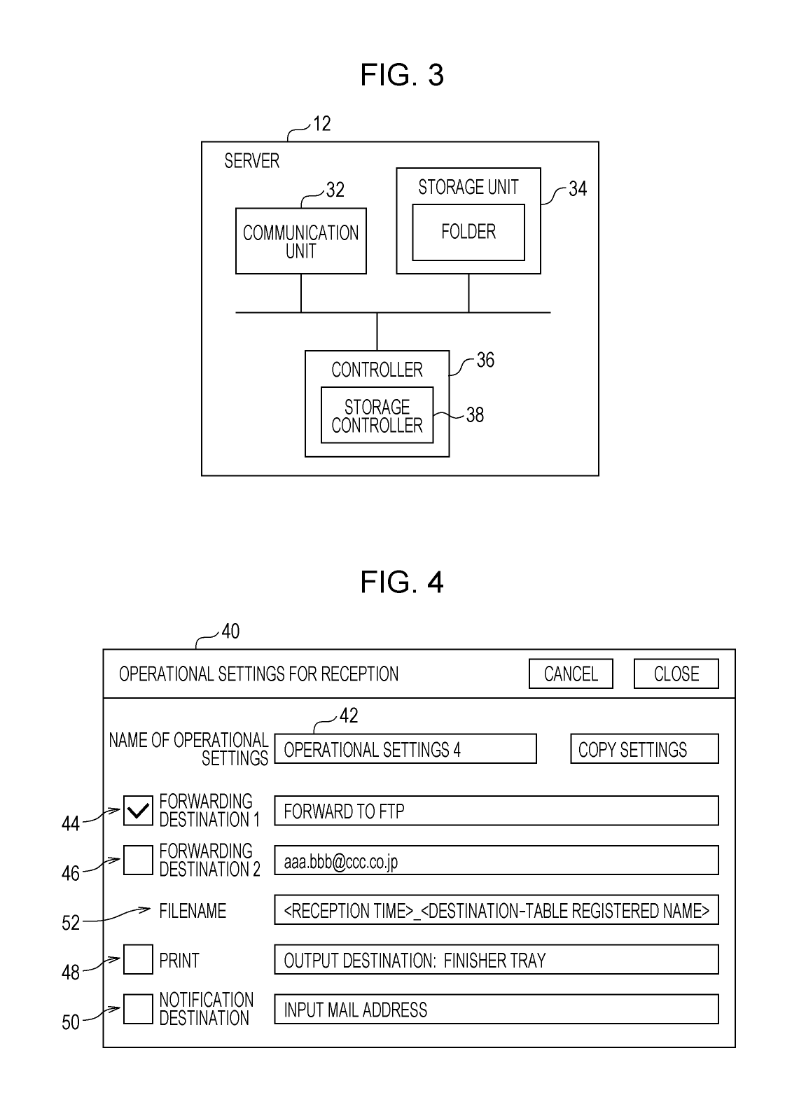

The configuration of the server 12 will be described in detail below with reference to FIG. 3. FIG. 3 illustrates an example of the configuration of the server 12.

A communication unit 32 is a communication interface and has a function of transmitting data to another apparatus and a function of receiving data from another apparatus. The communication unit 32 may be a communication interface having a wireless communication function or may be a communication interface having a wired communication function. For example, the communication unit 32 receives facsimile data forwarded from the image forming apparatus 10 via the communication path N. Furthermore, the communication unit 32 may receive an electronic mail or another type of data (e.g., image data or document data) forwarded from the image forming apparatus 10 via the communication path N.

A storage unit 34 is a storage device, such as a hard disk. The storage unit 34 includes a folder as an example of a data storage location (storage area). The storage unit 34 includes one or multiple folders. In each folder, data forwarded from the image forming apparatus 10 (e.g., facsimile data) is stored. The storage unit 34 may store therein information other than facsimile data (e.g., address book data, communication history information, and other types of data).

A controller 36 has a function of controlling the operation of each component of the server 12. For example, the controller 36 controls communication performed by the communication unit 32. Moreover, the controller 36 includes the storage controller 38.

The storage controller 38 has a function of controlling storage of data forwarded from the image forming apparatus 10. In the first exemplary embodiment, in a case where facsimile data is forwarded from the image forming apparatus 10 to the server 12, the storage controller 38 stores the facsimile data in a folder linked with the FAX ID of the transmission source of the facsimile data. If a folder linked with the FAX ID of the transmission source is not detected (i.e., if the server 12 does not have such a folder), the storage controller 38 creates a folder linked with the FAX ID of the transmission source and stores the facsimile data in the folder.

As mentioned above, in a case where the image forming apparatus 10 has the storage controller 30, the server 12 does not have to have the storage controller 38. Needless to say, the image forming apparatus 10 and the server 12 may both have the respective storage controllers. In this case, either one of the storage controller 30 and the storage controller 38 controls the storage of facsimile data. In the following description, it is assumed that the storage of facsimile data is controlled by the storage controller 30 provided in the image forming apparatus 10.

The first exemplary embodiment will be described in further detail below.

The operational settings for facsimile reception will now be described. FIG. 4 illustrates an example of an operational setting screen. For example, when the user gives a command for displaying an operational setting screen by using the UI unit 24 of the image forming apparatus 10, the controller 28 of the image forming apparatus 10 causes the display unit of the UI unit 24 to display an operational setting screen 40. The operational setting screen 40 displays a name field 42, forwarding-destination selection fields 44 and 46, a print selection field 48, a notification-destination selection field 50, and a filename-rule selection field 52. The name field 42 is a field to which the user inputs the name of the operational settings.

Each of the forwarding-destination selection fields 44 and 46 is a field to be used by the user for selecting a forwarding destination of facsimile data. In the example shown in FIG. 4, a forward-to-FTP option (i.e., a forward-to-server-12 option) is selected as a forwarding destination 1 in the forwarding-destination selection field 44. In the forwarding-destination selection field 46, an electronic mail is selected as a forwarding destination 2 such that an electronic mail address of the forwarding destination is input. The forwarding-destination selection fields 44 and 46 are each provided with a checkbox. The selection is enabled when the checkbox is checked, whereas the selection is disabled when the check is removed. Alternatively, the selection may be enabled and disabled by a method other than using checkboxes. The same applies to the other selection fields. In the example shown in FIG. 4, the checkbox for the forwarding-destination selection field 44 is checked such that the selection in the forwarding-destination selection field 44 is enabled. In this case, if the facsimile unit 18 receives facsimile data by facsimile communication, the communication unit 16 of the image forming apparatus 10 forwards the facsimile data to the server 12. Furthermore, the checkbox for the forwarding-destination selection field 46 is not checked such that the selection in the forwarding-destination selection field 46 is disabled. In this case, the communication unit 16 of the image forming apparatus 10 does not forward the facsimile data to the selected address via an electronic mail. In a case where the checkbox for the forwarding-destination selection field 46 is checked, the communication unit 16 of the image forming apparatus 10 forwards the facsimile data to the selected address by using electronic mail.

Although two forwarding destinations are selectable in the example shown in FIG. 4, only a single forwarding destination may be selectable, or three or more forwarding destinations may be selectable. Moreover, a forwarding option other than the forward-to-server 12 option and the electronic-mail-based forwarding option may be selected. For example, a forwarding option to the terminal apparatus 14 using a forwarding method other than the electronic-mail-based forwarding method, a forwarding option to another external apparatus (e.g., an image server provided in the cloud), or a storing option to a storage location provided in the image forming apparatus 10 may be selected.

The print selection field 48 is used by the user for selecting whether or not facsimile data is to be printed. Moreover, an output destination for printed paper is also selected in the print selection field 48. In the example shown in FIG. 4, a checkbox for the print selection field 48 is not checked, such that the selection in the print selection field 48 is disabled. In this case, the printing unit 20 of the image forming apparatus 10 does not print the facsimile data onto paper. When the checkbox for the print selection field 48 is checked, the printing unit 20 of the image forming apparatus 10 prints the facsimile data onto paper. In this case, the printed paper is output to the selected output destination.

The notification-destination selection field 50 is used by the user for selecting a notification destination of facsimile reception. An electronic mail address as a notification destination is also selected in the notification-destination selection field 50. In the example shown in FIG. 4, a checkbox for the notification-destination selection field 50 is not checked, such that the selection in the notification-destination selection field 50 is disabled. In this case, the communication unit 16 of the image forming apparatus 10 does not notify the notification destination of information indicating that facsimile data has been received even if the facsimile unit 18 has actually received the facsimile data by facsimile communication. In a case where the facsimile unit 18 receives facsimile data by facsimile communication in a state where the checkbox of the notification-destination selection field 50 is checked, the communication unit 16 of the image forming apparatus 10 notifies the notification destination (i.e., the selected electronic mail address) of the information indicating that the facsimile data has been received.

The filename-rule selection field 52 is used by the user for selecting a rule for creating the name (i.e., filename) of facsimile data. The facsimile data is given a filename in accordance with the rule. The filename may be given in the image forming apparatus 10 or may be given at the storage destination of the facsimile data (e.g., the server 12). The filename creating rule will be described in detail later.

The operational contents may be set in the operational setting screen 40 for every facsimile line. For example, in a case where multiple facsimile lines are used, different operational settings may be set for each facsimile line, or identical operational settings may be set for multiple facsimile lines.

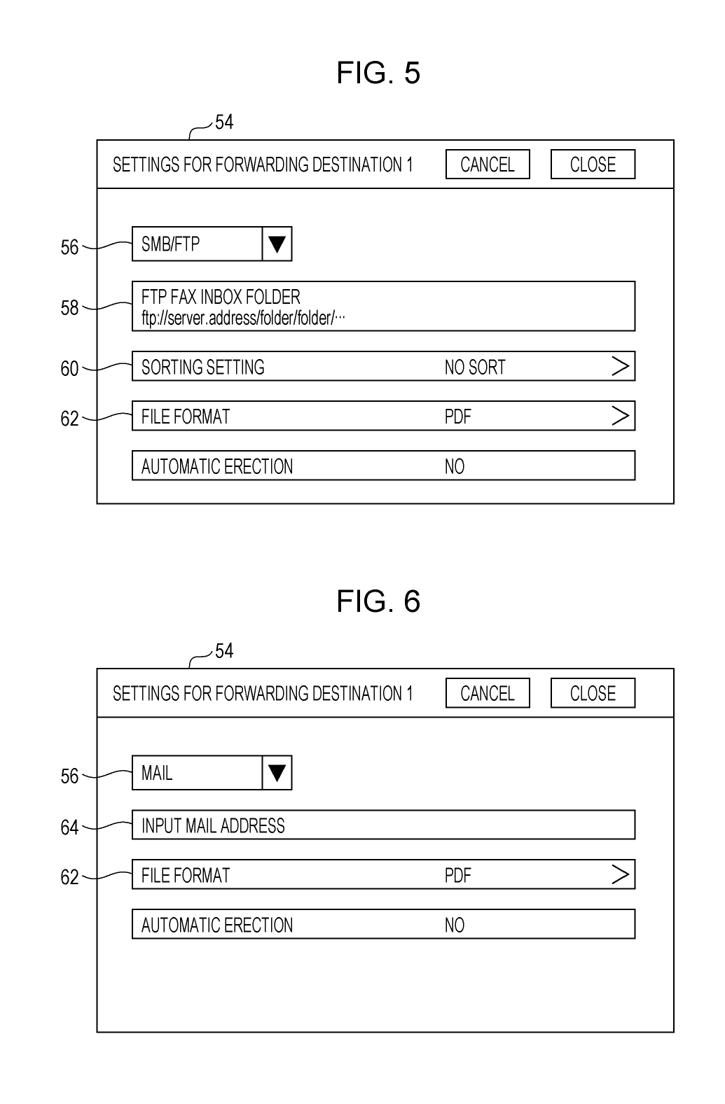

A forwarding-destination setting screen will be described in detail below. FIG. 5 illustrates an example of a forwarding-destination setting screen. For example, in a case where the user selects the forwarding-destination selection field 44 corresponding to the forwarding destination 1 in the operational setting screen 40 shown in FIG. 4, the controller 28 of the image forming apparatus 10 causes the UI unit 24 to display a setting screen 54 used for setting the forwarding details. The setting screen 54 displays a forwarding-destination selection field 56, a folder selection field 58, a sorting setting field 60, and a file-format selection field 62.

The forwarding-destination selection field 56 is used by the user for selecting a forwarding destination of facsimile data. In the example shown in FIG. 5, an “SMB/FTP” option (i.e., a forward-to-server-12 option) is selected by the user.

The folder selection field 58 is used by the user for selecting a folder in which facsimile data is to be stored. Specifically, an address of a folder as a storage destination is selected. The facsimile data is stored in the selected folder. The folder does not necessarily have to be selected in the folder selection field 58 by the user. In this case, the facsimile data is stored in a folder linked with the FAX ID of the transmission source of the facsimile data in accordance with storage control performed by the storage controller 30 or the storage controller 38.

The sorting setting field 60 is used by the user for selecting whether or not facsimile data is to be sorted. In the example shown in FIG. 5, a “no sort” option is selected. In this case, the facsimile data is stored in a predetermined folder (e.g., unclassified folder). If a “sort” option is selected, the facsimile data is sorted and stored in a specific folder in accordance with a sorting rule.

The file-format selection field 62 is used by the user for selecting a file format of facsimile data. The controller 28 of the image forming apparatus 10 generates facsimile data having the selected file format based on the facsimile data received by the facsimile unit 18. The facsimile data having the file format is stored or forwarded.

FIG. 6 illustrates another setting example. In the example shown in FIG. 6, an electronic-mail-based forwarding option is selected in the forwarding-destination selection field 56 by the user. In this case, an address selection field 64 is displayed on the setting screen 54. The address selection field 64 is used by the user for selecting an electronic mail address of a forwarding destination of facsimile data. The facsimile data is attached to an electronic mail and is forwarded to the selected electronic mail address. Similar to the example shown in FIG. 5, the facsimile data having the file format selected in the file-format selection field 62 is forwarded to the electronic mail address.

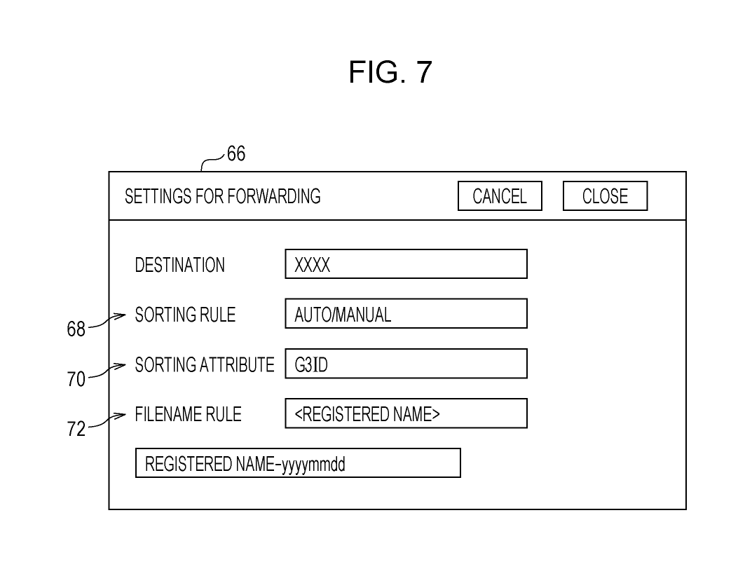

A facsimile-data forwarding-rule setting screen will be described below with reference to FIG. 7. FIG. 7 illustrates an example of the setting screen. For example, in a case where the user selects the “sort” option in the sorting setting field 60 in the setting screen 54 shown in FIG. 5, the controller 28 of the image forming apparatus 10 causes the UI unit 24 to display a setting screen 66 for setting the details of the forwarding rule. The setting screen 66 displays a sorting-rule selection field 68, a sorting-attribute selection field 70, and a filename-rule selection field 72.

The sorting-rule selection field 68 is used by the user for selecting whether facsimile data is to be sorted automatically or manually. In a case where the automatic sorting option is selected, if a folder linked with the FAX ID of the transmission source of the facsimile data does not exist, the storage controller 30 or the storage controller 38 automatically creates a folder linked with the FAX ID. In a case where the manual sorting option is selected, a folder is created by the user.

The sorting-attribute selection field 70 is used by the user for selecting the category (attribute) of FAX ID used for sorting facsimile data. For example, the user selects the category (attribute) of FAX ID from a facsimile number, a G3ID, and a dial-in number. In a case where the user selects the sorting-attribute selection field 70, the controller 28 of the image forming apparatus 10 may cause the setting screen 66 to display a facsimile number, a G3ID, and a dial-in number as categories (attributes) in accordance with a pull-down method or a pop-up method, and the user may select the category (attribute) of FAX ID from the display. In the example shown in FIG. 7, a G3ID is selected as the category (attribute) of FAX ID. In this case, the facsimile data is sorted by using the G3ID. For example, a folder linked with the G3ID of the transmission source of the facsimile data is created, and the facsimile data is stored in the folder. Alternatively, a default category (attribute) may be set. In this case, a folder linked with the FAX ID of the default category (attribute) is created. For example, a dial-in number may be set as a default category. In this case, a folder linked with the dial-in number of the transmission source of the facsimile data is created, and the facsimile data is stored in the folder.

Similar to the filename-rule selection field 52 shown in FIG. 4, the filename-rule selection field 72 is used by the user for selecting a rule for creating the name (i.e., filename) of facsimile data.

In the operational setting screen 40 shown in FIG. 4, the setting screen 54 shown in FIGS. 5 and 6, and the setting screen 66 shown in FIG. 7, the contents selected in the respective selection fields may be set in advance. In other words, default contents may be set in advance. In this case, if the user changes the preset contents in the respective selection fields, processing is performed in accordance with the changed contents.

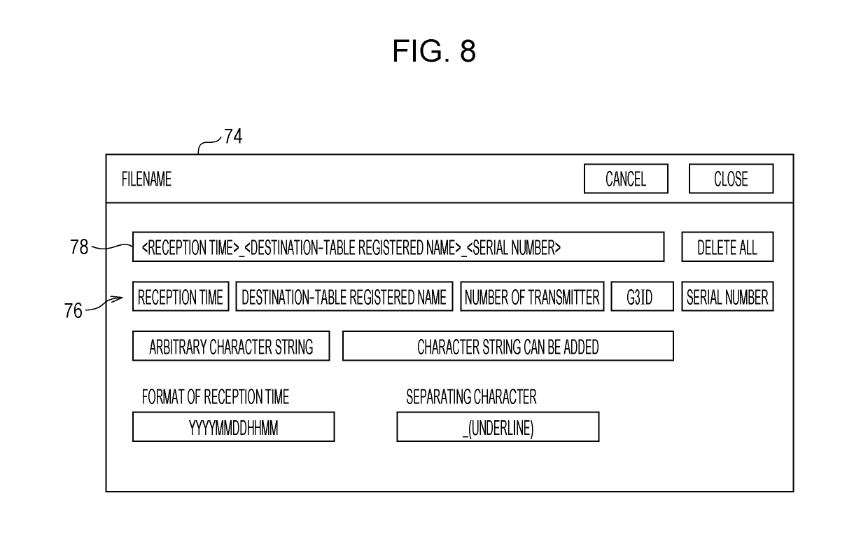

A filename-rule setting screen will be described below with reference to FIG. 8. FIG. 8 illustrates a filename-rule setting screen 74. For example, in a case where the user selects the filename-rule selection field 52 shown in FIG. 4 or the filename-rule selection field 72 shown in FIG. 7, the controller 28 of the image forming apparatus 10 causes the UI unit 24 to display the setting screen 74.

For example, a filename rule is a rule based on which a filename element selected from the time and date of facsimile reception, a registered name (e.g., the name of the communication partner (i.e., the transmission source) registered in the address book data), a transmitter number (i.e., the facsimile number of the communication partner (i.e., the transmission source)), a G3ID, and apparatus identification information for identifying the image forming apparatus 10 is to be included in the filename. The apparatus identification information is unique to each image forming apparatus 10 and is for uniquely identifying the image forming apparatus 10. For example, the apparatus identification information is a serial number of each image forming apparatus 10. The apparatus identification information used may be information other than a serial number so long as the apparatus identification information is identification information for uniquely identifying each image forming apparatus 10.

The setting screen 74 displays a button group 76 used for selecting filename elements. For example, a reception-time button, a registered-name button, a transmitter-number button, a G3ID button, and a serial-number button are displayed. When the user presses the reception-time button, the time and date of facsimile reception are selected as a filename element. When the user presses the registered-name button, the registered name indicating the transmission source is selected as a filename element. When the user presses the transmitter-number button, the transmitter number of the transmission source is selected as a filename element. When the user presses the G3ID button, the G3ID of the transmission source is selected as a filename element. When the user selects the serial-number button, the serial number of the image forming apparatus 10 that has received the facsimile data by facsimile communication is selected as a filename element. A filename is created based on the filename element selected by the user, and the filename is given to the facsimile data.

In the example shown in FIG. 8, the reception-time button, the registered-name button, and the serial-number button are pressed by the user, so that a filename including a character string indicating the time and date of facsimile reception, a character string indicating the registered name of the transmission source, and a character string indicating the serial number of the image forming apparatus 10 is given to the facsimile data. The filename elements selected by the user are displayed in an element display field 78. Additionally, the expression format of the time and date of reception may be selected by the user, and a freely-chosen character string to be included in the filename may be input by the user.

By including a serial number unique to each image forming apparatus 10 in the filename of facsimile data, the facsimile data is identified based on the serial number. For example, it is assumed that facsimile data is forwarded to the server 12 from each of multiple image forming apparatuses 10. In this case, the filename of the facsimile data forwarded from each image forming apparatus 10 to the server 12 includes the serial number of each image forming apparatus 10. Accordingly, supposing that multiple image forming apparatuses 10 receive facsimile data simultaneously from the same transmission source and the multiple image forming apparatuses 10 forward the facsimile data to the server 12, each piece of facsimile data is identified in the server 12 based on the serial number. In a case where the filenames are created by using the name of the transmission source, the time and date of reception, and the FAX ID instead of using the serial numbers, the multiple pieces of facsimile data received simultaneously from the same transmission source by the multiple image forming apparatuses 10 would not be distinguishable from one another. In this case, for example, a first piece of facsimile data may be overwritten in the server 12 by a second piece of facsimile data received from the same transmission source at the same time as the first piece of facsimile data. By creating the filenames by using the serial numbers as described above, such a problem may be prevented.

The filename elements may be set in advance. In other words, default filename elements may be set in advance. In this case, when the user selects a filename element, a filename including the filename element selected by the user is created.

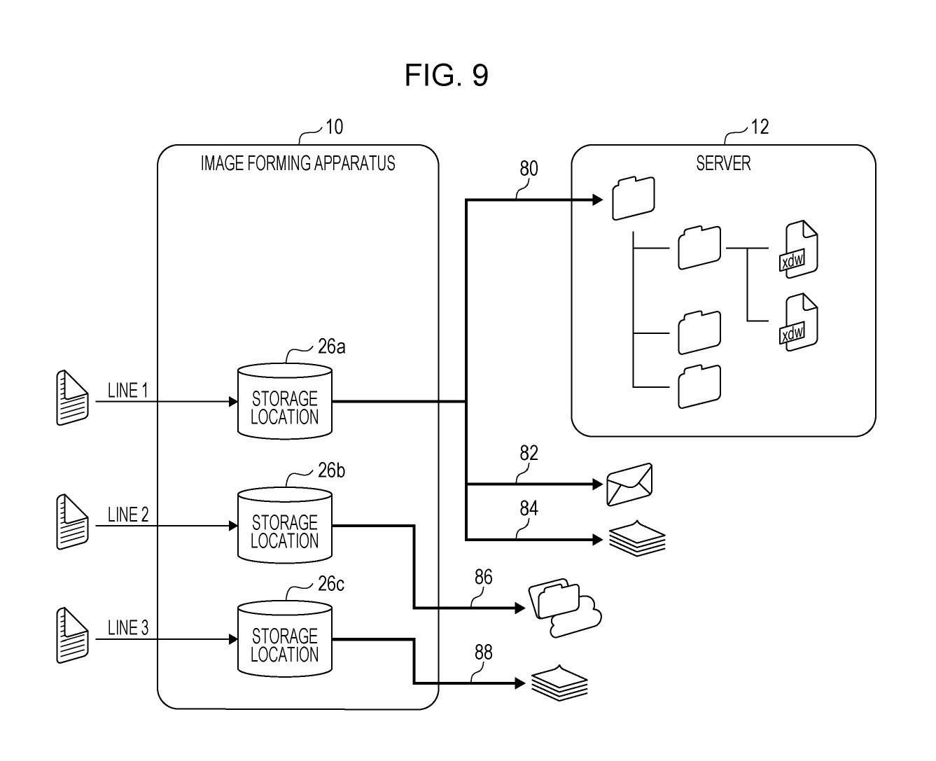

The operation of the data management system according to the first exemplary embodiment will be described in detail below with reference to FIG. 9. FIG. 9 illustrates the operational contents of the data management system. For example, it is assumed that three facsimile lines (facsimile lines 1, 2, and 3) are usable. In a case where multiple facsimile lines are used, a different FAX ID (i.e., the FAX ID allocated to the image forming apparatus 10) may be allocated to each facsimile line, or the same FAX ID (i.e., the FAX ID allocated to the image forming apparatus 10) may be allocated to the facsimile lines. The following description relates to an example where different FAX IDs are allocated to the respective facsimile lines.

In a case where the facsimile unit 18 receives facsimile data via the facsimile line 1, the facsimile data is stored in a storage location (i.e., storage area) 26a for the facsimile line 1 in the storage unit 26. In this case, the facsimile data may be temporarily stored until the facsimile data is forwarded or printed, or may be stored continually even after the facsimile data is forwarded or printed. The facsimile data has attribute information added thereto. The attribute information includes the FAX ID (e.g., the facsimile number, the G3ID, or the dial-in number) of the transmission source. The attribute information may alternatively include the name, the ID, and the station name of the transmission source as information other than the FAX ID.

As the operational contents with respect to the facsimile line 1, a forward-to-server-12 option, an electronic-mail-based forwarding option, and a printing option are set. In this case, the communication unit 16 of the image forming apparatus 10 acquires facsimile data from the storage location 26a and forwards the facsimile data to the server 12, as indicated by reference sign 80. Moreover, the communication unit 16 attaches the facsimile data to an electronic mail, as indicated by reference sign 82, and transmits the electronic mail to a preregistered destination (i.e., electronic mail address). The printing unit 20 of the image forming apparatus 10 acquires the facsimile data from the storage location 26a and prints the facsimile data onto paper as a recording medium, as indicated by reference sign 84. In the server 12, the facsimile data is sorted and stored in a folder in accordance with the forwarding rule selected in the setting screen 66 shown in FIG. 7. This storage control may be performed by the storage controller 30 of the image forming apparatus 10 or may be performed by the storage controller 38 of the server 12. The storage control will be described in detail later.

In a case where the facsimile unit 18 receives facsimile data via the facsimile line 2, the facsimile data is stored in a storage location (storage area) 26b for the facsimile line 2 in the storage unit 26. As described above, the facsimile data may be stored temporarily or may be stored continually.

As the operational contents with respect to the facsimile line 2, a forward-to-external-apparatus option (e.g., to an image server other than the server 12) is set. In this case, the communication unit 16 of the image forming apparatus 10 acquires the facsimile data from the storage location 26b and forwards the facsimile data to the external apparatus, as indicated by reference sign 86. In the external apparatus, the facsimile data is sorted and stored in a folder in accordance with the forwarding rule selected in the setting screen 66 shown in FIG. 7.

In a case where the facsimile unit 18 receives facsimile data via the facsimile line 3, the facsimile data is stored in a storage location (storage area) 26c for the facsimile line 3 in the storage unit 26. As described above, the facsimile data may be stored temporarily or may be stored continually.

As the operational contents with respect to the facsimile line 3, a printing option is set. In this case, the printing unit 20 of the image forming apparatus 10 acquires the facsimile data from the storage location 26c and prints the facsimile data onto paper, as indicated by reference sign 88.

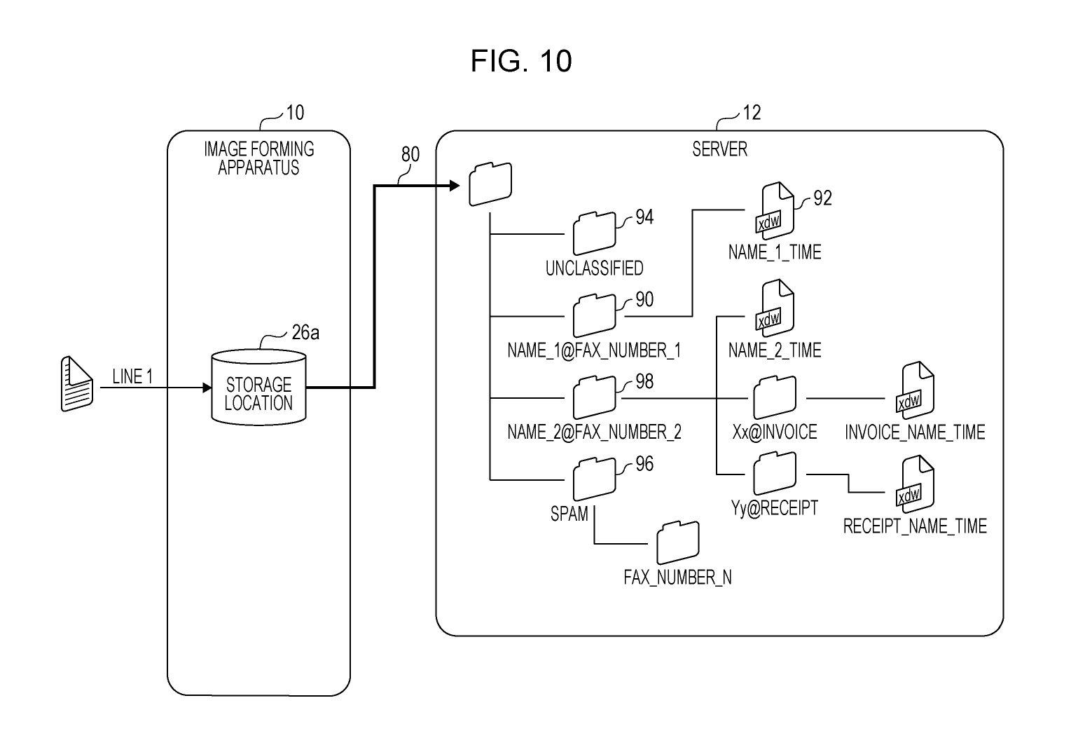

A facsimile-data storing process will be described in detail below with reference to FIG. 10. FIG. 10 illustrates an example of the storing process. In this case, the storing process indicated by reference sign 80 in FIG. 9 will be described. As described above with reference to FIG. 9, the facsimile data received via the facsimile line 1 is forwarded to the server 12 via the communication path N. The communication unit 32 of the server 12 receives the facsimile data forwarded from the image forming apparatus 10 via the communication path N. Furthermore, the storage controller 30 of the image forming apparatus 10 stores the facsimile data in a folder formed in the server 12 in accordance with the sorting attribute and the sorting rule set as the forwarding rule. The process performed by the storage controller 30 will be described in detail below. As mentioned above, this storing process may alternatively be performed by the storage controller 38 of the server 12.

The storage controller 30 uses the FAX ID included in the attribute information of the facsimile data as a search key to search for a folder linked with the FAX ID in the storage unit 34 of the server 12, and stores the facsimile data in the folder. In other words, the storage controller 30 searches for a folder having a folder name that includes the FAX ID and stores the facsimile data in the folder. For example, it is assumed that a “facsimile number” is selected as a sorting attribute. In this case, the storage controller 30 uses the facsimile number of the facsimile data as a search key to search for a folder having a folder name that includes the facsimile number, and then stores the facsimile data in the folder.

In a case where the automatic sorting option is selected as a sorting rule, if the storage unit 34 does not have a folder having a folder name that includes the facsimile number (i.e., if such a folder is not found), the storage controller 30 creates a new folder having a folder name that includes the facsimile number and stores the facsimile data in the folder. In a case where the manual sorting option is selected as a sorting rule, if the storage unit 34 does not have a folder having a folder name that includes the facsimile number (i.e., if such a folder is not found), the storage controller 30 stores the facsimile data in a predetermined folder (e.g., unclassified folder).

The process performed by the storage controller 30 will be described with reference to a specific example. If the facsimile number of the facsimile data forwarded from the image forming apparatus 10 to the server 12 is a “FAX number 1”, the storage controller 30 uses the character string “FAX number 1” as a search key to search for a folder 90 having a folder name that includes the character string “FAX number 1”, and stores the facsimile data in the folder 90. For example, a file 92 as the facsimile data is stored in the folder 90. A detailed description of how a filename is given will be provided later.

In a case where the automatic sorting option is selected as a sorting rule, if the storage unit 34 does not have the folder 90 (i.e., if the folder 90 is not found), the storage controller 30 creates a new folder 90 having a folder name that includes the character string “FAX number 1” and stores the facsimile data in the folder 90.

Furthermore, in a case where the storage controller 30 searches for the “FAX number 1” in the address book data and the “FAX number 1” is registered in the address book data, the storage controller 30 causes the folder name of the folder 90 to include the name (e.g., “name 1”) of the communication partner (i.e., the transmission source) linked with the “FAX number 1” and registered in the address book data. In other words, the storage controller 38 creates a folder 90 linked with a combination of the “name 1” and the “FAX number 1”, more specifically, a folder 90 having a folder name that includes the character string “name 1” and the character string “FAX number 1”. For example, the folder name of the folder 90 is “name_1@FAX_number_1”. The separator information “@” in the folder name is for separating the FAX ID and other information (e.g., the name of the transmission source) from each other in the folder name. The information after the separator information “@” is the FAX ID, and the information before the separator information “@” is the name of the transmission source. By including the separator information in the folder name in this manner, the FAX ID is specified in the folder name. The order in which the FAX ID and other information are written is not limited to that in the above example. The FAX ID may be written before the separator information “@”, and the name may be written after the separator information “@”. As a further alternative, separator information other than “@” may be used.

In a case where the “FAX number 1” is not registered in the address book data, the storage controller 30 creates a folder name that does not include the “name” of the communication partner (i.e., the transmission source) and gives the folder name to the folder 90. Even in this case, the folder 90 is searched by using the facsimile number as a search key since the folder name includes the “FAX number 1”, and facsimile data having the “FAX number 1” as a facsimile number is stored in the folder 90.

In a case where the address book data is stored in the image forming apparatus 10, the storage controller 30 searches for a FAX ID through the address book data stored in the image forming apparatus 10 so as to acquire a name linked with the FAX ID. If the address book data is stored in the server 12, the storage controller 30 searches for a FAX ID through the address book data stored in the server 12 so as to acquire a name linked with the FAX ID.

In a case where the storage unit 34 already has a folder 90 having a folder name that includes the character string “FAX number 1” (i.e., in a case where the folder 90 is found), if the character string “name” included in the folder name (i.e., the character string before “@”) is different from the “name” linked with the “FAX number 1” registered in the address book data, the storage controller 38 may change the character string “name” already included in the folder name of the folder 90 to the “name” registered in the address book data. In this case, the storage controller 30 does not have to change the character string “name” already included in the folder name of the folder 90.

In a case where the manual sorting option is selected as a sorting rule, if the storage unit 34 does not have the folder 90, the storage controller 30 stores the facsimile data in an unclassified folder 94.

Furthermore, a spam folder 96 may be provided. For example, a spam FAX ID is preregistered, and the storage controller 30 stores facsimile data linked with a FAX ID registered as a spam FAX ID in the spam folder 96. The storage controller 30 may create a folder for each spam FAX ID in the spam folder 96 and sort and store the spam facsimile data.

In a case where the facsimile number of facsimile data forwarded from the image forming apparatus 10 is a “FAX number 2”, a folder 98 having a folder name that includes the character string “FAX number 2” is searched, similarly to the case where the facsimile number is the “FAX number 1”, and the facsimile data is stored in the folder 98.

The following is a detailed description of how a filename is given to facsimile data. The storage controller 30 creates a filename in accordance with the filename rule, and links the filename with the facsimile data. For example, in a case where “reception time” and “registered name” are selected as filename elements, the storage controller 30 creates a filename that includes a character string indicating the time and date on which the facsimile data is received by facsimile communication and a character string indicating the name of the transmission source, and links the filename with the facsimile data. The file 92 shown in FIG. 10 is given a filename in accordance with this rule. The filename includes the character string “name 1” and the character string “reception time”. In a case where a serial number is selected as a filename element, as shown in FIG. 8, a character string indicating the serial number of the image forming apparatus 10 is included in the filename. The same applies to other filename elements. By including a serial number in a filename, the server 12 distinguishes and identifies each piece of facsimile data from other pieces of facsimile data even when multiple image forming apparatuses 10 receive facsimile data simultaneously from the same transmission source.

Although a folder name is created by using a name registered in the address book data in the above example, a folder name may alternatively be created by using a name included in the communication history information. In this case, the storage controller 30 searches for a FAX ID through the communication history information stored in the image forming apparatus 10 and includes the name of the communication partner (i.e., the transmission source) linked with the FAX ID in the folder name.

According to the first exemplary embodiment, a FAX ID of facsimile data, that is, a FAX ID allocated to the transmission source, is used as a name of a folder that is to store the facsimile data, and the facsimile data is stored in a folder having a folder name that includes the FAX ID of the facsimile data. Accordingly, for example, even in a case where the name of a communication partner registered in the address book data is changed, facsimile data transmitted from the same transmission source is stored in the same folder. For example, in a case where the name of a communication partner registered in the address book data is used as a folder name instead of using the FAX ID of the transmission source, if the name of the communication partner registered in the address book data is changed, facsimile data forwarded after this change is not stored in the folder given the name before the change but is stored in the folder given the name after the change. Thus, regardless of the fact that facsimile data forwarded prior to the change in the name and facsimile data forwarded after the change in the name are data transmitted by facsimile communication from the same transmission source, the two pieces of facsimile data are stored in different folders. According to the first exemplary embodiment, a folder is given a name including a FAX ID that uniquely indicates a transmission source so that, even when the name of the transmission source is changed, facsimile data transmitted by facsimile communication from the same transmission source is stored in the same folder.

### Modification

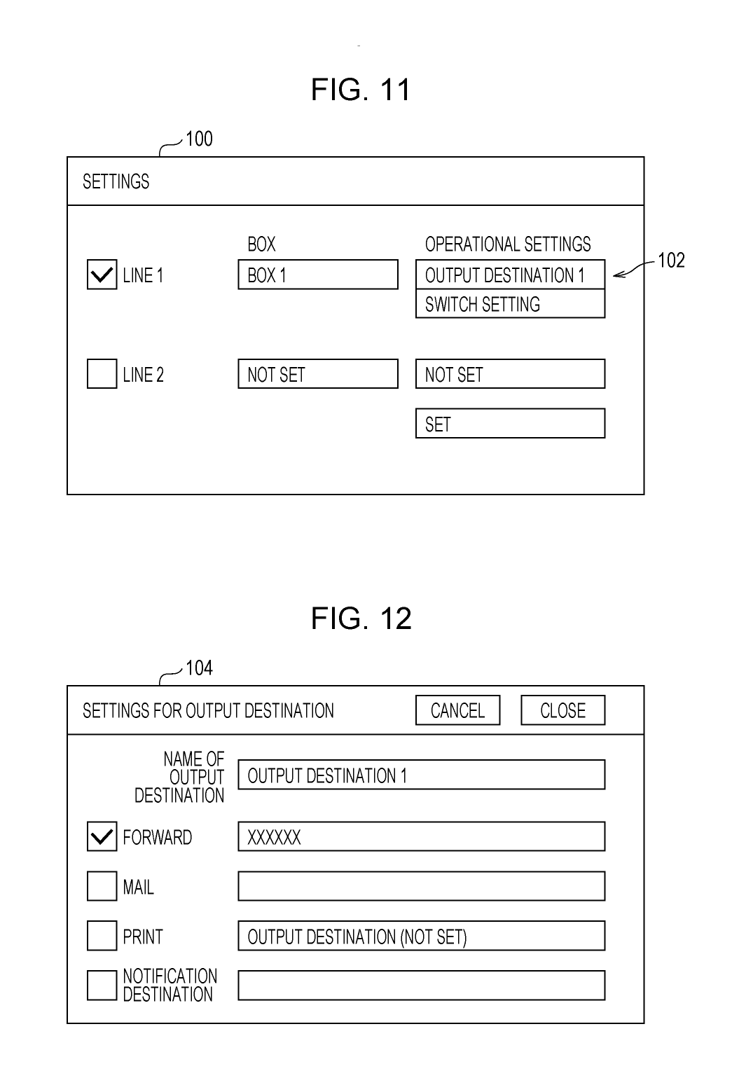

A modification of the first exemplary embodiment will be described below. FIG. 11 illustrates an example of an operational setting screen. An operational setting screen 100 is for setting operational contents for each facsimile line and is displayed on the UI unit 24 of the image forming apparatus 10 when performing an operational setting process. Although setting processes for facsimile lines 1 and 2 are possible in the example shown in FIG. 11, setting processes for three or more facsimile lines are also possible.

The operational setting screen 100 displays an operational-setting selection field 102 for each facsimile line, and a normal operation mode and an exceptional operation mode are settable in the operational-setting selection field 102. For example, when the user selects the operational-setting selection field 102, for example, information for setting a normal operation mode and an exceptional operation mode is displayed in accordance with a pull-down method or a pop-up method. In the normal operation settings, an output destination 1 of facsimile data (i.e., a forward-to-server-12 option, an electronic-mail-based forwarding option, or a printing option) is set, similarly to the first exemplary embodiment described above. In the exceptional operation settings, an output destination 2 in an exceptional period in which the output destination 1 is not applied is set.

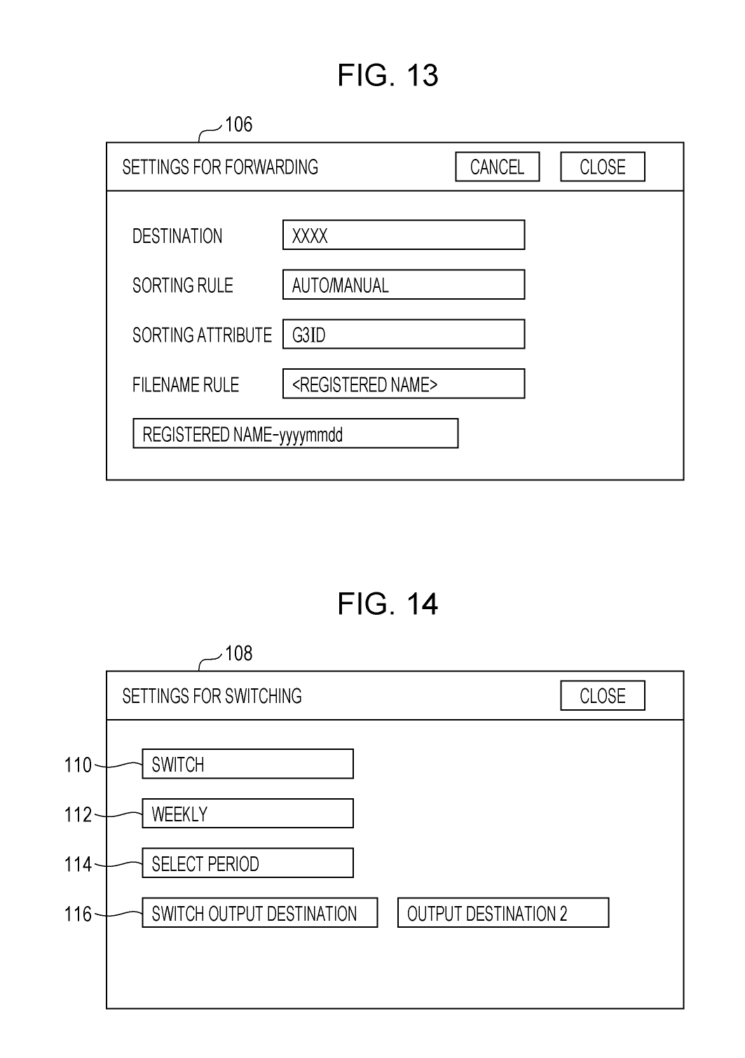

When the “output destination 1” is selected in the operational-setting selection field 102 by the user, the controller 28 of the image forming apparatus 10 causes the UI unit 24 to display a normal-output-destination setting screen 104 for setting the “output destination 1”, which is an output destination for normal operation, as shown in FIG. 12. Similar to the operational setting screen 40 shown in FIG. 4, the normal-output-destination setting screen 104 displays a setting field for forwarding facsimile data to the server 12, a setting field for forwarding facsimile data by using electronic mail, a setting field for printing facsimile data, and a setting field for a notification of facsimile reception. For example, when the user selects the setting field for forwarding facsimile data to the server 12, the controller 28 of the image forming apparatus 10 causes the UI unit 24 to display a setting screen 106 for setting a forwarding rule, as shown in FIG. 13. The setting screen 106 is the same as the setting screen 66 shown in FIG. 7. In this setting screen 106, for example, a sorting attribute is set. In the example shown in FIG. 12, the forward-to-server-12 option is selected as the “output destination 1” by the user. In this case, facsimile data is forwarded from the image forming apparatus 10 to the server 12 as normal operation, and the facsimile data is stored in a folder linked with the FAX ID of the facsimile data.

When the user selects a “switch setting” option in the operational-setting selection field 102 shown in FIG. 11, the controller 28 of the image forming apparatus 10 causes the UI unit 24 to display a switch setting screen 108 for setting the output destination 2, which is an output destination for exceptional operation, as shown in FIG. 14. The switch setting screen 108 displays a field 110 for selecting whether or not to perform switching, a field 112 for selecting the day and time frame in which the exceptional operation is to be performed, a field 114 for selecting an arbitrary period in which the exceptional operation is to be performed, and a field 116 for selecting a switch output destination.

When the user selects a “switch” option in the field 110 in FIG. 14, the exceptional operation is set to an enabled mode, whereas when a “no switch” option is selected, the exceptional operation is set to a disabled mode. In a case where the exceptional operation is set to an enabled mode, output operation set as the output destination 1 for normal operation is not performed during the period in which the exceptional operation is performed. Instead, output operation set as the output destination 2 for exceptional operation is performed.

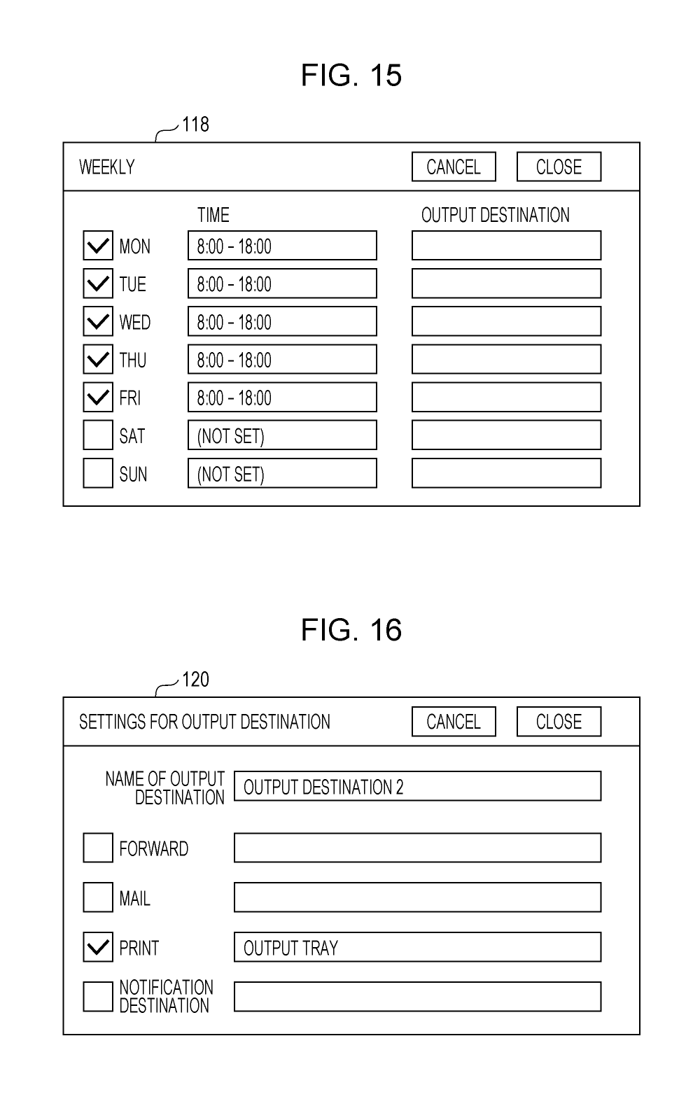

When the user selects the field 112 in FIG. 14, the controller 28 of the image forming apparatus 10 causes the UI unit 24 to display an exceptional-period setting screen 118, as shown in FIG. 15. In the exceptional-period setting screen 118, for example, a time frame for performing exceptional operation is settable for each day of the week. In the example shown in FIG. 15, the selected days are Monday to Friday, and the selected time frame is from 8:00 to 18:00. In this case, exceptional operation (output destination 2) is executed between 8:00 and 18:00 from Monday to Friday. For other days and time frames, normal operation (output destination 1) (e.g., the operation set in FIGS. 12 and 13) is executed.

When the user selects the field 114 in FIG. 14, the controller 28 of the image forming apparatus 10 causes the UI unit 24 to display an exceptional-period setting screen. In this exceptional-period setting screen, for example, the dates and time frames for performing exceptional operation are settable.

When the field 116 in FIG. 14 is selected, the controller 28 of the image forming apparatus 10 causes the UI unit 24 to display an exceptional-output-destination setting screen 120 for setting the “output destination 2”, which is an output destination for exceptional operation, as shown in FIG. 16. Similar to the normal-output-destination setting screen 104 shown in FIG. 12, the exceptional-output-destination setting screen 120 displays a setting field for forwarding facsimile data to the server 12, a setting field for forwarding facsimile data by using electronic mail, a setting field for printing facsimile data, and a setting field for a notification of facsimile reception. In the example shown in FIG. 16, the printing option is set as the “output destination 2” by the user. In this case, facsimile data is output to paper by the printing unit 20 as exceptional operation.

As described above, the forward-to-server-12 option is set as the output destination 1 in normal operation, whereas the printing option is set as the output destination 2 in exceptional operation. Furthermore, the time frame between 8:00 and 18:00 from Monday to Friday is set as the exceptional period. In this case, during the exceptional period, that is, during the period between 8:00 and 18:00 from Monday to Friday, facsimile data is printed onto paper by the printing unit 20 instead of being forwarded to the server 12. During the normal operation period (i.e., periods other than the exceptional period), that is, during the period between 0:00 and 24:00 on Saturdays and Sundays, and during periods other than the period between 8:00 and 18:00 from Monday to Friday, facsimile data is forwarded to the server 12 instead of being printed, and is stored in a folder linked with the FAX ID of the facsimile data in the server 12.

In the example described above, the forward-to-server-12 option is set as normal operation and the printing option is set as exceptional operation. Alternatively, the printing option may be set as normal operation and the forward-to-server-12 option may be set as exceptional operation. Moreover, the electronic-mail-based forwarding option or the facsimile-reception notification option may be set as normal operation or exceptional operation.

Furthermore, multiple output destinations 1 may be set, and multiple output destinations 2 may be set. Moreover, default normal operation (output destination 1) may be set in advance, or default exceptional period or exceptional operation (output destination 2) may be set in advance. In this case, the facsimile data is output in accordance with the default settings. The default setting contents may be changed by the user.

According to this modification, facsimile data may be output in accordance with the user's situation or the user's convenience. For example, during a period in which the user is staying in an office, the facsimile data may be set to be printed onto paper, and during a period in which the user is out of the office, the electronic-mail-based forwarding option or the forward-to-server-12 option may be set so that output according to the user's schedule may be executed.

The controller 28 of the image forming apparatus 10 may acquire data indicating the user's schedule and may set the output destination, the normal period, and the exceptional period based on the schedule. For example, for a time frame in which the user is planning to leave the office, the option for storing data in the server 12 or the option for forwarding data to the user's terminal apparatus by using electronic mail may be set as an output destination, and for a time frame in which the user is planning to stay in the office, the printing option may be set as an output destination.

In the first exemplary embodiment described above, the data that is to undergo the storing process is facsimile data. Alternatively, the storing process according to the first exemplary embodiment may be applied to data other than facsimile data. For example, in a case where the communication unit 16 of the image forming apparatus 10 receives an electronic mail, the storage controller 30 may store the electronic mail in a folder linked with an electronic mail address allocated to the transmission source of the electronic mail. The electronic mail address corresponds to an example of identification information of the transmission source. If a folder linked with the electronic mail address of the transmission source is not detected, the storage controller 30 creates a folder linked with the electronic mail address of the transmission source and stores the electronic mail in the folder. The storage controller 30 may store data (e.g., document data or image data) attached to the electronic mail in the folder together with the electronic mail. The folder may be created in the image forming apparatus 10, in the server 12, or in another apparatus (e.g., the terminal apparatus 14). Furthermore, in a case where the electronic mail is to be forwarded to the server 12 and is to be stored within the server 12, the storage controller 38 of the server 12 may execute the storing process for the electronic mail.

In a case where the printing option is set as a process with respect to an electronic mail, the printing unit 20 prints the contents of the electronic mail onto paper. In a case where the electronic-mail-based forwarding option is set as a process with respect to an electronic mail, the communication unit 16 forwards the electronic mail to an electronic mail address of a forwarding destination.

In a case where the communication unit 16 of the image forming apparatus 10 receives data, such as image data or document data, as data other than an electronic mail, the data, such as image data or document data, is stored in a folder linked with identification information of the transmission source of the data (e.g., information indicating the address of the transmission source (such as an IP address or a MAC address)), similarly to the above-description.

In a case where the printing option is set as a process with respect to image data or document data, the printing unit 20 prints the image or document onto paper. In a case where the electronic-mail-based forwarding option is set as a process with respect to image data or document data, the communication unit 16 forwards the image data or the document data to a forwarding destination. The communication unit 16 may attach the image data or the document data to an electronic mail and transmit the electronic mail to an electronic mail address of the forwarding destination.

The terminal apparatus 14 may alternatively have a storage controller. For example, in a case where the terminal apparatus 14 receives an electronic mail, the storage controller of the terminal apparatus 14 stores the electronic mail in a folder linked with an electronic mail address of the transmission source of the electronic mail. The folder may be a folder within the terminal apparatus 14 or may be a folder within an external apparatus, such as the server 12. Furthermore, in a case where the terminal apparatus 14 receives data, such as image data or document data, the storage controller of the terminal apparatus 14 may store the data in a folder linked with identification information of the transmission source of the data.

### Second Exemplary Embodiment

A data management system according to a second exemplary embodiment will be described below. The data management system according to the second exemplary embodiment has a configuration identical to that of the data management system according to the first exemplary embodiment.

In the second exemplary embodiment, in a case where the image forming apparatus 10 receives data from a transmission source, if information related to the transmission source is registered in management information (e.g., address book data or communication history information), the storage controller 30 creates a folder linked with the transmission source and stores the data in the folder. If the information related to the transmission source is not registered in the management information, the storage controller 30 stores the data in a predetermined specific folder (e.g., unclassified folder).

The management information mentioned above may be management information linked with the image forming apparatus 10 (i.e., address book data or communication history information for the image forming apparatus 10), or may be management information linked with the user logged in the image forming apparatus 10 (i.e., address book data or communication history information for the user).

In a case where the aforementioned management information is stored in the image forming apparatus 10, if the information related to the transmission source is registered in the management information, that is, if the information related to the transmission source is stored in the image forming apparatus 10 as the transmission source, the storage controller 30 may create a folder linked with the transmission source and store data in the folder. If the information related to the transmission source is not stored in the image forming apparatus 10, the storage controller 30 stores data in a predetermined specific folder (e.g., unclassified folder).

The aforementioned data may be facsimile data, an electronic mail, or another type of data (e.g., image data or document data).

The information related to the transmission source is, for example, identification information of the transmission source and, specifically, is information indicating the name of the transmission source, the FAX ID of the transmission source, or information indicating the address of the transmission source (e.g., an electronic mail address, an IP address, or a MAC address).

For example, in a case where the facsimile unit 18 of the image forming apparatus 10 receives facsimile data from a transmission source by facsimile communication, if the information related to the transmission source is registered in the management information (e.g., address book data or history information), the storage controller 30 creates a folder linked with the transmission source and stores the facsimile data in the folder. In a case where the information related to the transmission source is not registered in the management information, the storage controller 30 stores the facsimile data in a predetermined specific folder (e.g., unclassified folder). In a case where the FAX ID of the transmission source as the information related to the transmission source is registered in the management information, the storage controller 30 creates a folder linked with the transmission source and stores the facsimile data in the folder. In a case where the FAX ID of the transmission source is not registered in the management information, the facsimile data may be stored in a predetermined folder.

Furthermore, in a case where the communication unit 16 of the image forming apparatus 10 receives an electronic mail from a transmission source, if the information related to the transmission source is registered in the management information, the storage controller 30 creates a folder linked with the transmission source and stores the electronic mail in the folder. In a case where the information related to the transmission source is not registered in the management information, the storage controller 30 stores the electronic mail in a predetermined folder. In a case where the electronic mail address of the transmission source as the information related to the transmission source is registered in the management information, the storage controller 30 creates a folder linked with the transmission source and stores the electronic mail in the folder. In a case where the electronic mail address of the transmission source is not registered in the management information, the electronic mail may be stored in a predetermined folder.

In a case where the communication unit 16 of the image forming apparatus 10 receives data, such as image data or document data, from a transmission source, if the information related to the transmission source is registered in the management information, the storage controller 30 creates a folder linked with the transmission source and stores the data in the folder. In a case where the information related to the transmission source is not registered in the management information, the storage controller 30 stores the data in a predetermined folder. In a case where the IP address or the MAC address of the transmission source as the information related to the transmission source is registered in the management information, the storage controller 30 creates a folder linked with the transmission source and stores the data in the folder. In a case where the IP address or the MAC address of the transmission source is not registered in the management information, the data may be stored in a predetermined folder.

For example, the storage controller 30 creates a folder linked with the identification information (e.g., the name, FAX ID, electronic mail address, IP address, or MAC address) of the transmission source as a folder linked with the transmission source. The information about at least one of the name of the transmission source, the FAX ID of the transmission source, the electronic mail address of the transmission source, the IP address of the transmission source, and the MAC address of the transmission source is linked with the folder as the identification information of the transmission source.

In a case where facsimile data is received, the storage controller 30 may create a folder linked with the FAX ID of the transmission source. In a case where an electronic mail is received, the storage controller 30 may create a folder linked with the electronic mail address of the transmission source. In a case where data, such as image data or document data, is received, the storage controller 30 may create a folder linked with the IP address or the MAC address of the transmission source.

The above-described folder may be created in the image forming apparatus 10, in the server 12, in the terminal apparatus 14, or in another apparatus. In a case where data is to be forwarded to the server 12 and is to be stored in the server 12, the storage controller 38 of the server 12 may execute the storing process for the data.

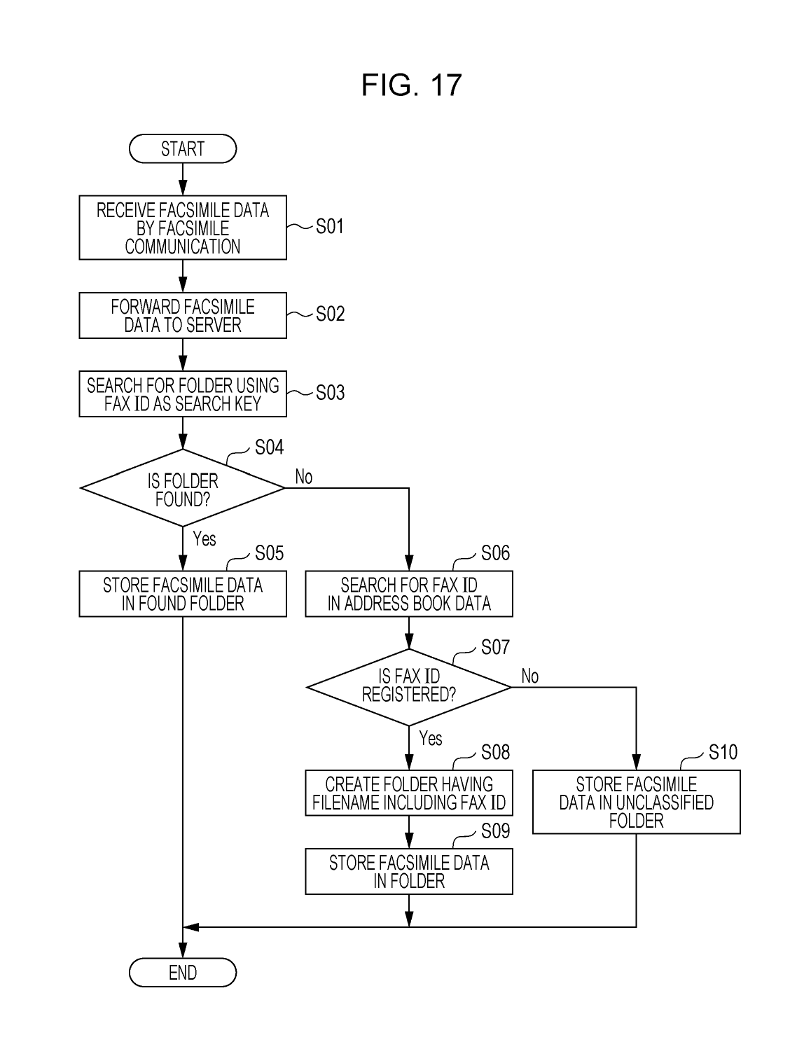

The operation of the data management system according to the second exemplary embodiment will be described below with reference to FIG. 17. FIG. 17 illustrates a flowchart of the operation. The following description relates to a case where the image forming apparatus 10 receives facsimile data as an example of data by facsimile communication. As mentioned above, the facsimile data is merely an example, and a process similar to that for facsimile data is executed in a case where another type of data (e.g., an electronic mail, image data, or document data) is transmitted to the image forming apparatus 10.

In step S01, the image forming apparatus 10 receives facsimile data from another apparatus (i.e., a transmission source) by facsimile communication. In this case, the facsimile data is processed in accordance with set operational contents, as in the first exemplary embodiment. It is assumed that a forward-to-server-12 option is set as the operational contents. In this case, the communication unit 16 of the image forming apparatus 10 transmits the facsimile data to the server 12 in step S02.

In step S03, the storage controller 30 of the image forming apparatus 10 uses a FAX ID (e.g., “FAX number 1”) of the transmission source included in attribute information of the facsimile data as a search key so as to search through the server 12 for a folder having a folder name that includes the FAX ID (e.g., “FAX number 1”) of the transmission source. If the folder is found, that is, if the storage unit 34 of the server 12 has such a folder (Yes in step S04), the storage controller 30 stores the facsimile data in the folder in step S05.

If a folder having a folder name that includes the FAX ID (e.g., “FAX number 1”) is not found, that is, if the storage unit 34 of the server 12 does not have such a folder (No in step S04), the storage controller 30 searches for identification information (e.g., FAX ID (“FAX number 1”)) of the transmission source in address book data in step S06. Although a FAX ID is searched as an example of the identification information of the transmission source, identification information other than a FAX ID may be searched. Moreover, for example, the aforementioned address book data may be address book data linked with the image forming apparatus 10 or may be address book data linked with a logged-in user.

If the identification information (e.g., FAX ID (“FAX number 1”)) of the transmission source is registered in the address book data (Yes in step S07), the storage controller 30 creates a new folder having a folder name that includes the identification information (e.g., the FAX ID (character string “FAX number 1”)) of the transmission source in step S08 and stores the facsimile data in the folder in step S09. In this case, the storage controller 38 may allow the folder name to include the name (e.g., “name 1”) of the communication partner (i.e., the transmission source) linked with the FAX ID (“FAX number 1”) and registered in the address book data. Accordingly, the character string “name_1@FAX_number_1” is created as a folder name, as in the first exemplary embodiment.

In a case where the identification information (e.g., the FAX ID (“FAX number 1”)) of the transmission source is not registered in the address book data (No in step S07), the storage controller 30 stores the facsimile data in a predetermined folder (e.g., unclassified folder) in step S10.

According to the second exemplary embodiment, in a case where there is no folder linked with the identification information (e.g., FAX ID) of the transmission source of the facsimile data, if the identification information (e.g., FAX ID) of the transmission source is registered in the address book data, a folder linked with the identification information (e.g., FAX ID) of the transmission source is created, and the facsimile data is stored in the folder. Normally, it is predicted or expected that a communication partner whose identification information (e.g., FAX ID) is registered in the address book data and the image forming apparatus 10 communicate with each other. For example, it is predicted or expected that the image forming apparatus 10 transmits facsimile data to the communication partner by facsimile communication, and it is predicted or expected that the facsimile data is transmitted from the communication partner to the image forming apparatus 10 by facsimile communication. Thus, by creating a folder linked with the FAX ID and storing the facsimile data therein, the facsimile data from the communication partner assumed to communicate with the image forming apparatus 10 is stored in the folder linked with the communication partner.

Consequently, the labor load on the user may be reduced, as compared with a case where the user creates the folder. On the other hand, it is normally not predicted or expected that a communication partner whose FAX ID is not registered in the address book data and the image forming apparatus 10 communicate with each other. For example, it is not predicted or expected that the image forming apparatus 10 transmits facsimile data to the communication partner by facsimile communication, and it is not predicted or expected that facsimile data is transmitted to the image forming apparatus 10 from the communication partner by facsimile communication. Thus, by storing the facsimile data in the unclassified folder without creating a folder linked with the FAX ID, a folder unique to the facsimile data is prevented from being created in contradiction to the prediction or expectation of the user.

Although address book data is used in the above-described example, communication history information may be used as an alternative. For example, in a case where there is no folder linked with the FAX ID of the transmission source of the facsimile data, if the history (e.g., facsimile communication history, electronic-mail exchange history, or exchange history of another type of data) of communication with the communication partner to which the FAX ID is allocated is recorded in the communication history information, the storage controller 30 creates a folder linked with the FAX ID and stores the facsimile data in the folder. On the other hand, if the history of communication with the communication partner to which the FAX ID is allocated is not recorded in the communication history information, the storage controller 30 stores the facsimile data in the unclassified folder. It is predicted that facsimile data will not be transmitted to the image forming apparatus 10 by facsimile communication from a communication partner (i.e., transmission source) with which the image forming apparatus 10 has not communicated in the past, or that the frequency of facsimile communication with such a communication partner is low. Thus, by not creating a folder linked with the FAX ID of a communication partner with which the image forming apparatus 10 has not communicated in the past, a folder predicted to be used at low frequency is prevented from being created. Furthermore, it is predicted that facsimile data transmitted from a communication partner with which the image forming apparatus 10 has not communicated in the past corresponds to spam facsimile data. According to the second exemplary embodiment, a folder unique to data predicted as being spam facsimile data may be prevented from being created.

In a case where the history of communication with a communication partner is not recorded in the communication history information and the communication partner is not registered in the address book data, the storage controller 30 stores the facsimile data transmitted from the communication partner by facsimile communication in the unclassified folder. In other cases, the storage controller 30 may create a folder linked with the FAX ID allocated to the communication partner and store the facsimile data in the folder.

Furthermore, in a case where the transmission source (i.e., communication partner) is a partner that has previously communicated with the image forming apparatus 10 within a predetermined specific period, the storage controller 30 may create a folder linked with the FAX ID allocated to the transmission source and store the facsimile data in the folder. In other cases, the storage controller 30 stores the facsimile data in the unclassified folder. For example, the specific period extends from the current point to a point backdated therefrom by a predetermined time. For example, a communication partner that has communicated with the image forming apparatus 10 within one previous year corresponds to a partner that has previously communicated with the image forming apparatus 10 within the specific period. Accordingly, facsimile data from a communication partner that has communicated with the image forming apparatus 10 at an immediately preceding point or in a preceding period is stored in a folder unique to the communication partner. In other cases, the facsimile data is stored in the unclassified folder.

Furthermore, in a case where a communication partner (e.g., a communication partner A) that has transmitted facsimile data to the image forming apparatus 10 by facsimile communication is a communication partner to which the image forming apparatus 10 has transmitted facsimile data by facsimile communication in the past, the storage controller 30 may create a folder linked with the FAX ID allocated to the communication partner A and store the facsimile data from the communication partner A in the folder. In other cases, the storage controller 30 stores the facsimile data in the unclassified folder. Accordingly, a folder unique to a communication partner to which the user using the image forming apparatus 10 is expected to transmit facsimile data by facsimile communication in the future is created. In other cases, such a folder unique to the communication partner is not created, thereby achieving improved user friendliness, as compared with a case where such a unique folder is created in other cases. Likewise, in a case where the data to be processed is an electronic mail, if a communication partner that has transmitted the electronic mail to the image forming apparatus 10 is a communication partner that has transmitted an electronic mail to the image forming apparatus 10 in the past, the storage controller 30 creates a folder linked with the identification information (e.g., electronic mail address) of the communication partner and stores the electronic mail from the communication partner in the folder. In other cases, the storage controller 30 stores the electronic mail in the unclassified folder. The same applies to a case where image data or document data is transmitted to the image forming apparatus 10.

In a case where a communication partner (e.g., a communication partner B) that has transmitted facsimile data to the image forming apparatus 10 by facsimile communication is a communication partner to which the image forming apparatus 10 has failed to transmit facsimile data by facsimile communication in the past, the storage controller 30 may store the facsimile data in the unclassified folder without creating a folder linked with the FAX ID allocated to the communication partner B. In other cases, the storage controller 30 creates a folder linked with the FAX ID and stores the facsimile data in the folder. Since it is not necessary to create a folder unique to a communication partner corresponding to failed facsimile transmission, a folder not necessary for the user is less likely to be created. Likewise, in a case where the data to be processed is an electronic mail, if a communication partner that has transmitted the electronic mail to the image forming apparatus 10 is a communication partner to which the image forming apparatus 10 has failed to transmit an electronic mail in the past, the storage controller 30 stores the electronic mail in the unclassified folder without creating a folder linked with the identification information (e.g., electronic mail address) of the communication partner. In other cases, the storage controller 30 creates a folder linked with the communication partner and stores the electronic mail in the folder. The same applies to a case where image data or document data is transmitted to the image forming apparatus 10.

The modification of the first exemplary embodiment may be applied to the second exemplary embodiment. In this case, for example, facsimile data is forwarded to the server 12 during the normal operation period, and printing and electronic-mail-based forwarding are performed during the exceptional period.

In the second exemplary embodiment described above, the data that is to undergo the storing process is facsimile data. Alternatively, as described above, the storing process according to the second exemplary embodiment may be applied to data other than facsimile data.

Furthermore, the terminal apparatus 14 may alternatively have a storage controller. For example, in a case where the terminal apparatus 14 receives an electronic mail, the storage controller of the terminal apparatus 14 searches for the identification information of the transmission source in the management information (i.e., address book data or communication history information). In a case where the identification information of the transmission source is registered in the management information, the storage controller of the terminal apparatus 14 creates a folder linked with the identification information of the transmission source and stores the electronic mail in the folder. In a case where the identification information of the transmission source is not registered in the management information, the storage controller of the terminal apparatus 14 stores the electronic mail in a predetermined specific folder (e.g., unclassified folder). The folder may be created in the terminal apparatus 14 or may be created in an external apparatus, such as the server 12. The management information may be stored in the terminal apparatus 14 or may be stored in an external apparatus, such as the server 12. Furthermore, in a case where the terminal apparatus 14 receives data, such as image data or document data, if the identification information of the transmission source of the data is registered in the management information, the storage controller of the terminal apparatus 14 creates a folder linked with the identification information of the transmission source and stores the data in the folder. If the identification information of the transmission source is not registered in the management information, the storage controller of the terminal apparatus 14 stores the data in a predetermined specific folder (e.g., unclassified folder).

### Third Exemplary Embodiment

A data management system according to a third exemplary embodiment will be described below. The data management system according to the third exemplary embodiment has a configuration identical to that of the data management system according to the first exemplary embodiment.

In the third exemplary embodiment, the communication unit 16 of the image forming apparatus 10 attaches facsimile data to an electronic mail and transmits the electronic mail to a predetermined electronic mail address. The facsimile data is forwarded to the destination by using electronic mail in this manner. The address of the forwarding destination is set in, for example, the operational setting screen 40 shown in FIG. 4, the setting screen 54 shown in FIG. 6, or the setting screen 104 shown in FIG. 12.

The controller 28 of the image forming apparatus 10 may control electronic-mail-based forwarding of facsimile data or other processes (e.g., printing of facsimile data onto paper) in accordance with the forwarding conditions. Although the following description relates to a case where a process of printing facsimile data onto paper is described as another process, for example, a facsimile-reception notification process or a forward-to-server-12 process may be performed as a process other than printing. The forwarding conditions will be described in detail below.

Forwarding Condition: Time Frame

One example of a forwarding condition is a time-frame-related condition. For example, the controller 28 of the image forming apparatus 10 controls electronic-mail-based forwarding of facsimile data in a forwarding time frame, and controls printing of facsimile data onto paper in a time frame other than the forwarding time frame. The forwarding time frame is set in, for example, the setting screen 118 shown in FIG. 15. The forwarding time frame may be set for each day of the week, each date, or each month, or may alternatively be set as an arbitrary time frame.

The time-frame-based control will be described in further detail. In a case where the time (including, for example, the time and date or the day of the week) at which the facsimile unit 18 of the image forming apparatus 10 receives facsimile data by facsimile communication is included in the aforementioned forwarding time frame, the controller 28 attaches the facsimile data to an electronic mail and controls the communication unit 16 so as to transmit the electronic mail to a predetermined forwarding destination. On the other hand, if the time at which the facsimile unit 18 of the image forming apparatus 10 receives the facsimile data by facsimile communication is not included in the aforementioned forwarding time frame, the controller 28 controls the printing unit 20 so as to print the facsimile data onto paper.

By controlling electronic-mail-based forwarding of facsimile data in accordance with the forwarding time frame, output of the facsimile data is performed in accordance with the user's convenience or situation. For example, in a case where the image forming apparatus 10 is installed in an office, a time frame in which the user is out of the office is set as the aforementioned forwarding time frame. In this case, since the facsimile data is printed onto paper in the time frame in which the user is in the office, the user may refer to the contents of the facsimile data printed on the paper. Accordingly, since the user is able to refer to the paper, the facsimile data does not have to be forwarded by using electronic mail. In contrast, in the time frame in which the user is out of the office, the facsimile data is transmitted to the forwarding destination by using electronic mail. By setting the electronic mail address of a user's terminal apparatus (e.g., a personal computer (PC), a tablet PC, or a smartphone) as the forwarding destination, the facsimile data is transmitted to the user. As a result, the user may refer to the contents of the facsimile data even when the user is out of the office.

Alternatively, multiple forwarding time frames may be set, and multiple electronic mail addresses may be registered as transmission destinations of the electronic mail to which the facsimile data is attached.

Forwarding Condition: Data Volume

Another example of a forwarding condition is a condition related to the volume of facsimile data. For example, the controller 28 of the image forming apparatus 10 controls electronic-mail-based forwarding of facsimile data if the volume of facsimile data received by the facsimile unit 18 is smaller than a predetermined threshold value, and controls printing of the facsimile data onto paper if the volume of the facsimile data is larger than or equal to the threshold value. The threshold value is set in, for example, the setting screen displayed on the UI unit 24 of the image forming apparatus 10. Alternatively, a default threshold value may be set.

The data-volume-based control will be described in further detail. If the volume of the facsimile data received by the facsimile unit 18 of the image forming apparatus 10 by facsimile communication is smaller than the threshold value, the controller 28 attaches the facsimile data to an electronic mail and controls the communication unit 16 so as to transmit the electronic mail to a predetermined forwarding destination. On the other hand, if the volume of the facsimile data received by facsimile communication is larger than or equal to the threshold value, the controller 28 controls the printing unit 20 so as to print the facsimile data onto paper.

By performing a data-volume-based forwarding process, the communication load at the receiver side of the electronic mail (e.g., user's terminal apparatus) is reduced. The aforementioned threshold value may be set for each electronic mail address registered as a forwarding destination. Accordingly, a forwarding process according to the communication capability (e.g., the download capacity limit) or the communication status (e.g., the communication speed of the communication path used) is performed for each forwarding destination.

If the volume of the facsimile data is larger than or equal to the threshold value, the controller 28 of the image forming apparatus 10 may divide the facsimile data into multiple pieces and transmit one or more pieces of data included in a data group generated as a result of the division individually to a forwarding destination by using electronic mail. The controller 28 may attach a single piece of data to a single electronic mail and transmit the electronic mail, or may attach multiple pieces of data to a single electronic mail and transmit the electronic mail. For example, multiple pieces of data may be attached to a single electronic mail within a range smaller than or equal to a predetermined permissible volume.

Furthermore, if the volume of the facsimile data is larger than or equal to the threshold value, the controller 28 of the image forming apparatus 10 may compress the facsimile data, attach the compressed data to an electronic mail, and transmit the electronic mail. In this case, the controller 28 may divide the facsimile data into multiple pieces of data and compress the multiple pieces of data generated as a result of the division.

As another example, electronic-mail-based forwarding or paper printing may be executed in accordance with the communication status in the communication path between the forwarding destination of the electronic mail and the image forming apparatus 10. For example, the electronic-mail-based forwarding may be executed if the communication speed in the communication path is higher than or equal to a threshold value, and the paper printing may be executed if the communication speed is lower than the threshold value. Moreover, either the electronic-mail-based forwarding or the paper printing may be executed in accordance with the specifications of the apparatus serving as a forwarding destination.

Forwarding Condition: Positional Relationship

Another example of a forwarding condition is related to the position of a user (i.e., user's terminal apparatus) registered as a forwarding destination of an electronic mail. For example, the controller 28 of the image forming apparatus 10 controls electronic-mail-based forwarding of facsimile data or output of facsimile data onto paper in accordance with the position of the user registered as a forwarding destination.

More specifically, the forwarding condition relates to the positional relationship between the user registered as a forwarding destination and the output destination (e.g., the image forming apparatus 10) of paper onto which the facsimile data is to be output. At the time point when the facsimile unit 18 of the image forming apparatus 10 receives facsimile data by facsimile communication, if the distance between the user and the image forming apparatus 10 is smaller than or equal to a predetermined threshold value, the controller 28 of the image forming apparatus 10 controls the printing unit 20 so as to print the facsimile data onto paper. If the distance between the user and the image forming apparatus 10 is larger than or equal to the threshold value, the controller 28 attaches the facsimile data to an electronic mail and controls the communication unit 16 so as to transmit the electronic mail to the user's terminal apparatus registered as a forwarding destination. Accordingly, in a case where the user is located relatively near the image forming apparatus 10, the facsimile data is printed onto paper. In a case where the user is located relatively far from the image forming apparatus 10, the facsimile data is forwarded to the user by using electronic mail.

For example, the controller 28 of the image forming apparatus 10 uses the global positioning system (GPS) to acquire information indicating the position of the image forming apparatus 10 and information indicating the position of the user's terminal apparatus registered as a forwarding destination. The controller 28 uses the positional information acquired in this manner so as to determine the positional relationship between the user and the image forming apparatus 10.

Furthermore, in a case where the user registered as a forwarding destination is located within a specific area including the paper output destination (e.g., the image forming apparatus 10), the controller 28 may control the printing unit 20 so as to print the facsimile data onto paper. If the user is not located within the specific area, the controller 28 may attach the facsimile data to an electronic mail and control the communication unit 16 so as to transmit the electronic mail to the user's terminal apparatus registered as a forwarding destination.

For example, the controller 28 uses the GPS to acquire information indicating the position of the user's terminal apparatus registered as a forwarding destination, and determines whether or not the user is located within the specific area based on the positional information.

As another example, a doorway for the specific area may be provided with a gate or a door, and the gate or the door may be provided with a device for managing user access. The device is, for example, a communication device that performs communication using near field communication (NFC). Each user may hold an ID card (e.g., an employee card, a registration card, or an access management card constituted of an integrated-circuit (IC) card) to the communication device, so that user's entry to the specific area and user's exit from the specific area are managed. The managing process is performed by, for example, an access management server. The controller 28 acquires information related to the access of the user registered as a forwarding destination from the access management server, and determines whether or not the user is located within the specific area based on the information.

The aforementioned specific area is, for example, an office, a classroom, a shop, or a library. For example, it is assumed that the image forming apparatus 10 is installed in an office. In a case where the facsimile unit 18 receives facsimile data by facsimile communication when a user registered as a forwarding destination is located within the office, the facsimile data is printed onto paper. On the other hand, in a case where the facsimile unit 18 receives facsimile data by facsimile communication when a user registered as a forwarding destination is not located within the office, the facsimile data is attached to an electronic mail, and the electronic mail is transmitted to a user's terminal apparatus.

Accordingly, by using the position of the user or the position of the image forming apparatus 10, output of facsimile data according to the status related to the position of the user is realized.

Forwarding Condition: User's Schedule

Another example of a forwarding condition is related to the schedule of a user registered as a forwarding destination of an electronic mail. For example, the controller 28 of the image forming apparatus 10 controls electronic-mail-based forwarding of facsimile data or printing of facsimile data onto paper in accordance with the schedule of the user registered as a forwarding destination.

Information indicating the user's schedule (referred to as “schedule information” hereinafter) may be stored in, for example, a user's terminal apparatus, an apparatus such as the management server, or the image forming apparatus 10. For example, the user's schedule is set on a yearly basis, monthly basis, weekly basis, daily basis, and hourly basis, and the schedule information indicates a schedule set in this manner. The controller 28 of the image forming apparatus 10 acquires the schedule information of the user registered as a forwarding destination of the electronic mail from an apparatus, such as the terminal apparatus or the management server.

For example, it is assumed that the image forming apparatus 10 is installed in an office. In a case where the facsimile unit 18 receives facsimile data by facsimile communication, the controller 28 acquires the schedule information of the user registered as a forwarding destination and estimates the location of the user based on the schedule information. For example, in a case where the user is scheduled to go out at the time of reception of the facsimile data, it is assumed that the user will not be in the office. Therefore, the controller 28 attaches the facsimile data to an electronic mail and transmits the electronic mail to the user's terminal apparatus (i.e., terminal apparatus registered as a forwarding destination). If it is assumed that the user will be in the office at the time of reception of the facsimile data, the controller 28 prints the facsimile data onto paper. If the user is not able to immediately retrieve the paper having the facsimile data printed thereon, such as when the user is attending a meeting, the controller 28 may transmit the electronic mail having the facsimile data attached thereto to the user's terminal apparatus.

By utilizing the user's schedule in the above-described manner, output of facsimile data according to the user's schedule is realized.

In the third exemplary embodiment, the FAX ID of the transmission source of facsimile data and the user serving as a forwarding destination of an electronic mail (i.e., user's electronic mail address) may be set in correspondence with each other in advance, and information indicating a correspondence therebetween may be stored in the image forming apparatus 10. In this case, when the facsimile unit 18 receives facsimile data by facsimile communication, the controller 28 refers to the information indicating the correspondence so as to determine the user (i.e., electronic mail address) corresponding to the FAX ID of the transmission source. Subsequently, the controller 28 transmits an electronic mail having the facsimile data attached thereto to the electronic mail address of the user. Accordingly, facsimile data is individually transmitted to a forwarding destination set for each transmission source of facsimile data.

In a case where the electronic mail having the facsimile data attached thereto is deleted from the terminal apparatus that has received the electronic mail, the controller 28 of the image forming apparatus 10 may refuse (prohibit) reception of new facsimile data from the transmission source of the facsimile data or may prohibit electronic-mail-based forwarding of new facsimile data. This process will be described in detail. As mentioned above, in a case where an electronic mail is deleted from the terminal apparatus serving as a forwarding destination, the terminal apparatus transmits information indicating the deletion via the server 12 or directly to the image forming apparatus 10. The information indicating the deletion includes the FAX ID of the facsimile data attached to the deleted electronic mail. When the controller 28 of the image forming apparatus 10 receives the information indicating the deletion, the controller 28 refuses to receive new facsimile data from the communication partner to which the FAX ID included in the information indicating the deletion is allocated. In this case, the facsimile unit 18 does not receive facsimile data transmitted by facsimile communication from the communication partner to which the FAX ID is allocated. Moreover, in a case where new facsimile data is transmitted from the communication partner by facsimile communication, the controller 28 does not transmit an electronic mail to which the new facsimile data is attached to the user's terminal apparatus registered as a forwarding destination even if the electronic-mail-based forwarding option is set in an enabled mode. When an electronic mail is deleted, it is assumed that the facsimile data attached to the electronic mail is not useful data for the user. Thus, by performing the above-described control, facsimile data from a transmission source that is not useful for the user is prevented from being transmitted to the user's terminal apparatus by electronic mail.

As another example, in a case where the electronic mail having the facsimile data attached thereto is deleted from the terminal apparatus that has received the electronic mail, the storage controller 38 of the server 12 may store new facsimile data from the transmission source of the above facsimile data in a specific folder not dependent on the transmission source. The specific folder is, for example, an unclassified folder or a spam folder. Accordingly, facsimile data from a transmission source that is assumed to be not useful for the user is prevented from being stored in a folder unique to the transmission source.

### Other Exemplary Embodiments

In the above exemplary embodiments, a security process may be applied to facsimile data stored in a folder. This security process is performed by the controller 28 of the image forming apparatus 10 or by the controller 36 of the server 12. For example, a password may be set for the folder or the facsimile data, such that access to the folder or the facsimile data is permitted only to a specific user (e.g., a user having an administrative right or a user belonging to a specific group). Furthermore, a security level may be set for each transmission source of facsimile data, such that a process according to the security level is applied to the folder or the facsimile data. For example, the right of a user permitted to access a folder or facsimile data may be set in accordance with the security level. Moreover, the security level may be set in accordance with the contents (keywords) of a document expressed by facsimile data. For example, a text-character recognition process, such as an optical character recognition (OCR) process, is applied to a document, and the security level is set in accordance with keywords included in the document.

In a case where a folder is already created in the storage unit 34 of the server 12, the storage controller 38 may use a specific character string included in the name of the folder (i.e., folder name) as a search key and apply a text-character recognition process to facsimile data. If the search key is included in the facsimile data, the storage controller 38 stores the facsimile data in the folder having the folder name that includes the specific character string used as the search key. If the search key is not included in the facsimile data, the storage controller 38 stores the facsimile data in the unclassified folder. For example, in a case where the folder name includes the separator information “@”, a character string after or before the separator information is used as a search key. For example, in a case where the folder name includes the character string “claims”, the character string “claims” is used as a search key, and facsimile data expressing a document including the character string “claims” is stored in the folder having the folder name that includes the character string “claims” (see FIG. 9). Accordingly, the facsimile data is classified by using the folder name.

The image forming apparatus 10, the server 12, and the terminal apparatus 14 described above are realized in accordance with, for example, hardware and software operating in cooperation with each other. Specifically, the image forming apparatus 10, the server 12, and the terminal apparatus 14 each include one or more processors, such as one or more central processing units (CPUs) (not shown). The one or more processors read a program stored in a storage device (not shown) and execute the program so as to realize the functions of the components included in the image forming apparatus 10, the server 12, and the terminal apparatus 14. The program is stored in the storage device via a recording medium, such as a compact disc (CD) or a digital versatile disc (DVD), or via a communication path, such as a network. As another example, the components of the image forming apparatus 10, the server 12, and the terminal apparatus 14 may each be realized by a hardware resource, such as a processor, an electronic circuit, or an application specific integrated circuit (ASIC). In order to achieve this, a device, such as a memory device, may be used. As another example, the components of the image forming apparatus 10, the server 12, and the terminal apparatus 14 may each be realized by a digital signal processor (DSP) or a field programmable gate array (FPGA).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiver that receives data from a transmission source; and
a controller that creates a storage location linked with the transmission source and stores the data in the storage location in a case where information related to the transmission source is registered in management information for managing a communication partner.

2. The information processing apparatus according to claim 1,
wherein the management information is stored in the information processing apparatus, and
wherein the controller creates the storage location and stores the data in the storage location in a case where the information related to the transmission source is stored in the information processing apparatus.

3. The information processing apparatus according to claim 1,
wherein the controller creates the storage location and stores the data in the storage location in a case where the storage location linked with the transmission source is not detected.

4. The information processing apparatus according to claim 1,
wherein, as the storage location linked with the transmission source, the controller creates the storage location linked with identification information allocated to the transmission source for performing communication.

5. The information processing apparatus according to claim 4,
wherein the controller creates the storage location linked with a combination of a name of the transmission source and the identification information of the transmission source.

6. The information processing apparatus according to claim 5,
wherein the management information indicates, for each communication partner, a correspondence between a name of the communication partner and identification information of the communication partner, and
wherein the controller creates the storage location linked with the combination of the name set in correspondence with the identification information of the transmission source in the management information and the identification information of the transmission source.

7. The information processing apparatus according to claim 6,
wherein the management information is address book data for managing the identification information of the communication partner or history information indicating a history of communication with the communication partner.

8. The information processing apparatus according to claim 4,
wherein the receiver receives the data from the transmission source by facsimile communication, and
wherein the identification information is facsimile identification information allocated to the communication partner for performing the facsimile communication.

9. The information processing apparatus according to claim 8,
wherein the facsimile identification information includes information about at least one of a facsimile number and a communication number according to a standard of the facsimile communication.

10. The information processing apparatus according to claim 1,
wherein the controller does not create a storage location linked with a transmission source with which the information processing apparatus has failed to communicate.

11. The information processing apparatus according to claim 1,
wherein the controller performs first control for printing the data onto a recording medium or second control for storing the data in the storage location.

12. The information processing apparatus according to claim 11,
wherein the controller stores the data in the storage location during a predetermined period and prints the data onto the recording medium outside the period.

13. The information processing apparatus according to claim 11,
wherein the controller executes the first control or the second control for every line used for communication.

14. A non-transitory computer readable medium storing a program causing a computer to execute a process for processing information, the process comprising:
receiving data from a transmission source; and
creating a storage location linked with the transmission source and storing the data in the storage location in a case where information related to the transmission source is registered in management information for managing a communication partner.

15. An information processing apparatus comprising:
receiving means for receiving data from a transmission source; and
control means for creating a storage location linked with the transmission source and stores the data in the storage location in a case where information related to the transmission source is registered in management information for managing a communication partner.
